(19) United States
(12) Patent Application Publication
(10) Pub. No.: US 2023/0249616 A1
(43) Pub. Date: Aug. 10, 2023

(54) VEHICLE INTERIOR COMPONENT

(71) Applicant: Shanghai Yanfeng Jinqiao Automotive Trim Systems Co., Ltd., Novi, MI (US)

(72) Inventors: Radisa Goeritz-Stamencic, Bad Schmiedeberg (DE); Salvatore Cutaia, Leverkusen (DE)

(21) Appl. No.: 17/665,076

(22) Filed: Feb. 4, 2022

(51) Int. Cl. B60Q 3/20; B60R 13/02; B32B 17/10; B32B 7/12

(52) U.S. Cl. CPC B60Q 3/20; B60R 13/02; B32B 17/10036; B32B 17/1044; B32B 7/12; B32B 17/10743; B32B 17/10266; B60R 2013/0287; B60R 2013/0281; B32B 2307/416; B32B 2307/732; B32B 2605/003

(57) ABSTRACT

A vehicle interior component configured for illumination by a light source is disclosed. The component may comprise a composite structure configured to provide a visual effect and comprising an intermediate layer between a base/substrate and a cover comprising a glass material. When illuminated, the composite structure may produce a composite visual effect on and/or within the composite structure, at a surface of the cover and/or at the intermediate layer. The cover may comprise an element and/or treatment to provide a visual effect. The intermediate layer may comprise a glass layer comprising an element and/or treatment to provide a visual effect. The composite visual effect may comprise a visual effect beneath the surface of the cover of the composite structure. The composite visual effect may comprise a depth effect when not illuminated and an enhanced depth effect when illuminated. A process to manufacture the component is also disclosed.

### CROSS-REFERENCE TO RELATED APPLICATIONS

The present application is a continuation of PCT/International Patent Application No. PCT/US2020/046866 titled “VEHICLE INTERIOR COMPONENT” filed Aug. 18, 2020, which claims the benefit of U.S. Provisional Patent Application No. 62/888,696 titled “VEHICLE COMPONENT” filed Aug. 19, 2019.

The present application claims priority to and incorporates by reference in full the following patent applications: (a) U.S. Provisional Patent Application No. 62/888,696 titled “VEHICLE COMPONENT” filed Aug. 19, 2019; (b) PCT/International Patent Application No. PCT/US2020/046866 titled “VEHICLE INTERIOR COMPONENT” filed Aug. 18, 2020.

### FIELD

The present invention relates to a vehicle interior component.

### BACKGROUND

It is known to provide a vehicle interior component with a glass cover.

It would be advantageous to provide an improved vehicle interior component comprising composite structure comprising a cover and a base and an intermediate layer configured to provide a visual effect. It would also be advantageous to provide an improved vehicle interior component in which the cover may comprise a glass layer. It would further be advantageous to provide a vehicle interior component in which the cover and/or the intermediate layer may be configured to provide the visual effect and in which the visual effect may comprise a decorative effect.

### SUMMARY

The present invention relates to a vehicle interior component configured for illumination by a light source comprising a composite structure comprising (a) a cover and (b) a base and (c) an intermediate layer between the cover and the base. The cover may comprise a surface and a cover layer comprising a glass material. The base may comprise a substrate. The composite structure may be configured to provide a visual effect. When the light source provides illumination the visual effect may comprise a composite visual effect; the composite structure may be configured to produce the composite visual effect on the composite structure and/or within the composite structure. The intermediate layer may comprise a decorative insert; the decorative insert may comprise a depth effect. The depth effect at the intermediate layer may be configured to be provided by illumination from the light source. The intermediate layer may comprise a treatment and/or an element configured to provide a visual effect. The treatment and/or element may comprise at least one of (a) an element on a film on a surface of a glass material of the intermediate layer; (b) an element on a coating on a surface of a glass material of the intermediate layer; (c) an element printed on a surface of a glass material of the intermediate layer; (d) an element painted on a surface of a glass material of the intermediate layer; (e) an element on a surface of a glass material of the intermediate layer; (f) a composite element on a surface of a glass material of the intermediate layer. The treatment and/or element may comprise at least one of (a) a decorative effect; (b) a coating; (c) printing; (d) paint; (e) a film; (f) a mask layer; (g) a mask; (h) a semi-reflective treatment; (i) a reflective treatment; (j) etching; (k) lasering; (l) engraving. The visual effect may comprise a first visual effect when the composite structure is in a first state; the first state may be unilluminated by the light source; the first state may comprise a depth effect. The visual effect may comprise a first visual effect when the composite structure is in a first state; the first state may be unilluminated by the light source; the visual effect may comprise a second visual effect when the composite structure is in a second state; the second state may be illuminated by the light source. The component may comprise a functional layer; the functional layer may comprise at least one of (a) a sensor; (b) a capacitive layer. The component may comprise indicia aligned with the functional layer on at least one of (a) an inner surface of the cover; (b) a surface of the intermediate layer.

The present invention relates to a vehicle interior component configured for illumination by a light source comprising a composite structure comprising (a) a cover and (b) a base and (c) an intermediate layer between the cover and the base. The cover may comprise a surface and a cover layer comprising a glass material. The base may comprise a substrate. The composite structure may be configured to provide a visual effect. The intermediate layer may comprise an inner layer comprising a glass layer. The glass layer may comprise an element; the element of the glass layer may comprise at least one of (a) an element on a film on a surface of the glass layer; (b) an element on a coating on a surface of the glass layer; (c) an element printed on a surface of the glass layer; (d) an element painted on a surface of the glass layer; (e) an element on a surface of the glass layer; (f) a composite element on each surface of the glass layer. The visual effect may comprise a pattern for the composite structure; the pattern may comprise at least one element of the glass layer of the intermediate layer of the composite structure. The glass layer may comprise glass of generally uniform thickness of between 0.2 mm and 1.8 mm.

The present invention relates to a vehicle interior component configured for illumination by a light source comprising a composite structure comprising (a) a cover and (b) a base and (c) an intermediate layer between the cover and the base. The cover may comprise a surface and a cover layer comprising a glass material. The base may comprise a substrate. The composite structure may be configured to provide a visual effect. The intermediate layer may comprise a first reflective layer and an inner layer and a second reflective layer. Transmittance and reflectance of the first reflective layer may be selected to produce a substantially reflective surface; reflectance of the second reflective layer may be selected to provide a mirror effect into the inner layer. Transmittance and reflectance of the first reflective layer and the second reflective layer may be selected to produce a depth effect; the depth effect may be produced from transmitted illumination and reflected illumination within the intermediate layer. The first reflective layer may comprise a one-way mirror coating. The cover may comprise a glass layer and a lamination; the intermediate layer may comprise a first inner glass layer and a treatment comprising a first reflective coating and a lamination and a second inner glass layer and a treatment comprising a second reflective coating and a safety film; the light source may comprise a back light.

The present invention relates to a vehicle interior component configured for illumination by a light source comprising a composite structure comprising (a) a cover and (b) a base and (c) an intermediate layer between the cover and the base. The cover may comprise a surface and a cover layer comprising a glass material. The base may comprise a substrate. The composite structure may be configured to provide a visual effect. When the light source provides illumination, the visual effect may comprise a composite visual effect; the composite structure may be configured to produce the composite visual effect on the composite structure and/or within the composite structure. The intermediate layer may comprise a decorative insert; the decorative insert may comprise a depth effect. The depth effect at the intermediate layer may be configured to be provided by illumination from the light source. The intermediate layer may comprise a treatment and/or an element configured to provide a visual effect. The treatment and/or element may comprise at least one of (a) an element on a film on a surface of a glass material of the intermediate layer; (b) an element on a coating on a surface of a glass material of the intermediate layer; (c) an element printed on a surface of a glass material of the intermediate layer; (d) an element painted on a surface of a glass material of the intermediate layer; (e) an element on a surface of a glass material of the intermediate layer; (f) a composite element on a surface of a glass material of the intermediate layer. The treatment and/or element may comprise at least one of (a) a decorative effect; (b) a coating; (c) printing; (d) paint; (e) a film; (f) a mask layer; (g) a mask; (h) a semi-reflective treatment; (i) a reflective treatment; (j) etching; (k) lasering; (l) engraving. The visual effect may comprise the element within the composite structure. The intermediate layer may comprise an inner layer comprising a glass layer. The glass layer may comprise an element; the element of the glass layer may comprise at least one of (a) an element on a film on a surface of the glass layer; (b) an element on a coating on a surface of the glass layer; (c) an element printed on a surface of the glass layer; (d) an element painted on a surface of the glass layer; (e) an element on a surface of the glass layer; (f) a composite element on each surface of the glass layer. The visual effect may comprise a pattern for the composite structure; the pattern may comprise at least one element of the glass layer of the intermediate layer of the composite structure. The visual effect may comprise a first visual effect when the composite structure is in a first state; the first state may be unilluminated by the light source. The first state may comprise a depth effect. The visual effect may comprise a second visual effect when the composite structure is in a second state; the second state may be illuminated by the light source. The second state may comprise an enhanced depth effect. The light source may comprise at least one of (a) a backlight; (b) a sidelight; (c) a backlight and a sidelight. At least one of the cover layer or the intermediate layer may comprise a glass material comprising a glass with a treatment comprising a treated surface. The treated surface may comprise at least one of (a) an etched surface; (b) a sand-blasted surface; (c) a scribed surface; (d) a laser scribed surface; (e) a surface configured to provide a tactile effect; (f) a surface configured to provide a haptic effect; (g) a surface configured to provide a texture appearance. The treatment may comprise at least one of (a) a coating; (b) printing; (c) painting; (d) inkjet printing; (e) a screen printing; (f) a laser ablated coating; (g) application of indicia; (h) etching; (i) laser ablation; (j) machining; (k) milling; (l) application of a reflective coating; (m) application of a semi-reflective coating; (n) application of a metalized coating; (o) application of a mirrored coating. The glass may comprise at least one of (a) tempered glass; (b) partially tempered glass; (c) chemically strengthened glass; (d) toughened glass; (e) thermally strengthened glass; (f) anti-reflective glass; (g) anti-glare glass; (h) iron-free glass; (i) coated glass; (j) mirror glass; (k) glass with a reflective coating. The composite structure may comprise a film layer. The cover may comprise a nonplanar surface. The intermediate layer may comprise a glass material; the glass material of the intermediate layer may comprise glass of generally uniform thickness of between 0.2 mm and 1.8 mm. The glass material of the intermediate layer may comprise glass of generally uniform thickness of between 0.55 mm and 1.1 mm. The glass may comprise at least one of (a) an iron-free glass material and (b) a chemically-strengthened glass material. The component may comprise a functional layer; the functional layer may comprise at least one of (a) a sensor; (b) a capacitive layer. The component may comprise indicia aligned with the functional layer on at least one of (a) an inner surface of the cover; (b) a surface of each inner layer.

The present invention relates to a vehicle interior component configured for illumination by a light source comprising a composite structure comprising (a) a cover and (b) a base and (c) an intermediate layer between the cover and the base. The cover may comprise a surface and a cover layer comprising a glass material. The base may comprise a substrate. The composite structure may be configured to provide a visual effect. The intermediate layer may comprise a first reflective layer and an inner layer and a second reflective layer. Transmittance and reflectance of the first reflective layer are selected to produce a substantially reflective surface; reflectance of the second reflective layer may be selected to provide a mirror effect into the inner layer. The mirror effect of the second reflective layer may comprise a substantially full mirror effect; the second reflective layer may comprise a light-transmissive pattern. Transmittance and reflectance of the first reflective layer and the second reflective layer may be selected to produce a depth effect; the depth effect may be produced from transmitted illumination and reflected illumination within the intermediate layer. The depth effect may comprise a repeated visual effect of a pattern. Illumination from the light source may be reflected between the first reflective layer and the second reflective layer to present a visual effect; the visual effect may comprise the pattern. The depth effect may comprise an infinity effect; the infinity effect may comprise a reflection effect within the intermediate layer; the reflection effect may comprise the pattern. The depth effect may be modified by distance between the first reflective layer and the second reflective layer. The second reflective layer may comprise a full mirror coating with apertures to permit transmission of illumination. The first reflective layer may comprise a one-way mirror coating. The intermediate layer may comprise an element between the first reflective layer and the second reflective layer; the element may comprise an object. The cover may comprise a glass layer and a lamination; the intermediate layer may comprise a first inner glass layer and a treatment comprising a first reflective coating and a lamination and a second inner glass layer and a treatment comprising a second reflective coating and a safety film; the light source may comprise a back light.

The present invention relates to a vehicle interior component manufactured by a process comprising the steps of forming a composite structure comprising a cover and a base and an intermediate layer between the cover and the base; applying a treatment to the intermediate layer; applying a film configured to hold the cover together when broken. The treatment may comprise at least one of (a) a decorative effect; (b) a coating; (c) printing; (d) paint.

The present invention relates to a vehicle interior component manufactured by a process comprising the steps of forming a generally clear cover; forming a generally clear inner layer; printing a film; joining the printed film to each inner layer with an optically clear adhesive; joining the cover, each inner layer with the printed film and a base. The film may be configured to hold the cover together when broken; the film may comprise at least one of (a) a decorative effect; (b) a coating; (c) printing; (d) paint configured to at least one of (1) block light; (2) transmit light; (3) diffuse light. The step of forming the cover may comprise at least one of (a) cutting the cover; (b) treating at least one edge of the cover; (c) deforming a planar surface of the cover into a nonplanar surface of the cover. The component may comprise at least one of (a) paint or printing on an inner surface of the cover; (b) paint or printing on an outer surface of each inner layer; (c) paint or printing on an inner surface of each inner layer.

The present invention relates to a vehicle interior component configured for illumination by a light source comprising: a composite structure comprising (a) a cover and (b) a base and (c) an intermediate layer between the cover and the base. The cover may comprise a surface and a cover layer comprising a glass material. The base may comprise a substrate. The composite structure may be configured to provide a visual effect. When the light source is off the visual effect of the composite structure may comprise a decorative effect. When the light source provides illumination, the visual effect may comprise a composite visual effect. The composite structure may be configured to produce the composite visual effect on the composite structure and/or within the composite structure. The composite structure may be configured to produce the composite visual effect at the surface of the cover and/or at the intermediate layer. The cover may be configured to provide a visual effect. The visual effect at the cover may comprise a decorative effect. The visual effect at the cover may be configured to be provided by illumination from the light source. The cover layer may comprise an element configured to provide a visual effect. The cover layer may comprise a treatment configured to provide a visual effect. The treatment may comprise an element configured to provide a visual effect. The intermediate layer may be configured to provide a visual effect. The visual effect of the intermediate layer may comprise a decorative effect. The intermediate layer may comprise a decorative insert. The decorative insert may comprise a visual effect. The decorative effect may comprise a depth effect. The visual effect may comprise a depth effect. The visual effect at the intermediate layer may be configured to be provided by illumination from the light source. The intermediate layer may comprise a glass layer comprising an element configured to provide a visual effect. The intermediate layer may comprise a treatment configured to provide a visual effect. The treatment may comprise an element configured to provide a visual effect. The element may comprise at least one of (a) an element on a film on a surface of the glass layer of the intermediate layer; (b) an element on a coating on a surface of the glass layer of the intermediate layer; (c) an element printed on a surface of the glass layer of the intermediate layer; (d) an element painted on a surface of the glass layer of the intermediate layer; (e) an element on a surface of the glass layer of the intermediate layer; (f) a composite element on each surface of the glass layer of the intermediate layer. The intermediate layer may comprise a treatment; the treatment may comprise at least one of (a) a treatment on a film on a surface of the glass layer of the intermediate layer; (b) a treatment on a coating on a surface of the glass layer of the intermediate layer; (c) a treatment printed on a surface of the glass layer of the intermediate layer; (d) a treatment painted on a surface of the glass layer of the intermediate layer; (e) a treatment on a surface of the glass layer of the intermediate layer; (f) a composite treatment on each surface of the glass layer of the intermediate layer; (g) the element of the intermediate layer. The treatment may comprise at least one of (a) a decorative effect; (b) a coating; (c) printing; (d) paint; (e) a film; (f) a mask layer; (g) a mask; (h) a semi-reflective treatment; (i) a reflective treatment; (j) etching; (k), lasering; (l) engraving. The intermediate layer may comprise an inner layer. The intermediate layer may comprise at least one of (a) an inner layer under the cover and (b) and inner layer over the base. The intermediate layer may comprise (a) an inner layer under the cover and (b) and inner layer over the base. The intermediate layer may comprise a first inner layer and a second inner layer. Each inner layer may comprise a glass layer. The glass layer may comprise an element; the element of the glass layer may comprise at least one of (a) an element on a film on a surface of the second glass layer; (b) an element on a coating on a surface of the second glass layer; (c) an element printed on a surface of the second glass layer; (d) an element painted on a surface of the second glass layer; (e) an element on a surface of the second glass layer; (f) a composite element on each surface of the second glass layer. The first glass layer may comprise the element. The second glass layer may comprise the element. The composite visual effect may comprise the element within the composite structure. The composite visual effect may comprise the element illuminated within the composite structure. The composite visual effect may comprise a depth effect of the element within the composite structure. The composite visual effect may comprise a visual effect beneath the surface of the cover of the composite structure. The composite visual effect may comprise a visual effect at the surface of the cover of the composite structure. The composite visual effect may comprise a pattern for the composite structure. The pattern may comprise the element of the glass layer of the intermediate layer of the composite structure. The composite visual effect may comprise a first visual effect when the composite structure is in a first state. The first state may be unilluminated by the light source. The first state may comprise a depth effect. The composite visual effect may comprise a second visual effect when the composite structure is in a second state. The second state may be illuminated by the light source. The second state may comprise a depth effect. The second state may comprise an enhanced depth effect. The light source may comprise at least one of (a) a diffuser; (b) a display panel; (c) a LED panel; (d) an LED array; (e) and LED display; (f) a backlight under the base layer; (g) a sidelight; (h) a backlight and a sidelight; (i) a light guide; (j) a light. The visual effect may comprise a depth effect; the depth effect may be produced at the intermediate layer. The depth effect may be provided by illumination at the intermediate layer by the light source. The depth effect may be enhanced by illumination at the intermediate layer by the light source. At least one of the cover layer or the intermediate layer may comprise a glass material comprising a glass with a treatment comprising a treated surface. The treated surface may comprise at least one of (a) an etched surface; (b) a sand-blasted surface; (c) a scribed surface; (d) a laser scribed surface; (e) a surface configured to provide a tactile effect; (f) a surface configured to provide a haptic effect; (g) a surface configured to provide a texture appearance. The treatment may comprise at least one of (a) a coating; (b) printing; (c) painting; (d) inkjet printing; (e) a screen printing; (f) a laser ablated coating; (g) application of indicia; (h) etching; (i) laser ablation; (j) machining; (k) milling; (l) application of a reflective coating; (m) application of a semi-reflective coating; (n) application of a metalized coating; (o) application of a mirrored coating. The glass may comprise at least one of (a) tempered glass; (b) partially tempered glass; (c) chemically strengthened glass; (d) toughened glass; (e) thermally strengthened glass; (f) anti-reflective glass; (g) anti-glare glass; (h) iron-free glass; (i) coated glass; (j) mirror glass; (k) glass with a reflective coating. The intermediate layer may comprise an inner layer with a reflective layer. The cover layer may comprise the surface of the cover. The cover may be configured to allow light to pass through the cover. The composite structure may comprise a film layer. The film layer may comprise a film applied to the substrate. The cover may comprise a nonplanar surface. The treatment may comprise a film configured to hold the cover together when broken. The treatment may comprise at least a portion configured to block light. The treatment may be coupled to the cover by at least one of (a) vacuum; (b) pressure; (c) heat; (d) light; (e) adhesive; (f) physical bonding; (g) chemical bonding; (h) static forces. The component may comprise a light source configured to provide light intended to be visible to an occupant in the vehicle when the component is in operation after installation in the interior of the vehicle. The treatment may comprise a substantially opaque portion and a substantially transparent portion; the substantially opaque portion may be configured to block light from the light source or to prevent light from the light source to pass through an inner layer toward an outer surface of the cover. The cover may comprise an outer surface configured to present a user interface using light from the light source. The component may comprise a sensor configured for interaction at the outer surface of the cover. The sensor may be configured to provide a user interface. The sensor may be configured to operate as an input device. The cover may comprise glass. The glass of the cover may comprise a generally uniform thickness of between 0.2 mm and 1.8 mm. The glass of the cover may comprise a generally uniform thickness of between 0.55 mm and 1.1 mm. The glass of the cover may comprise at least one of (a) an iron-free glass material and (b) a chemically-strengthened glass material. The cover may comprise an outer surface; the outer surface of the glass may comprise a treated surface comprising the treatment. The component may comprise a functional layer; the functional layer may comprise at least one of (a) a sensor; (b) a capacitive layer; (c) a resistive layer; (d) a camera. The intermediate layer may comprise at least one of (a) an inner layer under the cover and (b) and inner layer over the base. The intermediate layer may comprise (a) an inner layer under the cover and (b) and inner layer over the base. Each inner layer may comprise at least one of (a) a light guide; (b) glass; (c) a laminate; (d) wood; (e) metal; (f) stone; (g) a fabric; (h) mirror; (i) semi-reflective surface. Each inner layer may be configured to provide a depth effect. The component may comprise a film coupled to each inner layer; the film may be configured to hold at least one of (a) the cover; (b) each inner layer together when broken. The treatment may comprise at least a portion configured to block light. The treatment may comprise a decorative coating/printing. The treatment may be configured to provide a decorative effect. The component may comprise a bonding component configured to join the cover and each inner layer. The bonding component may comprise at least one of (a) a lamination film; (b) a cast resin; (c) a foil. The component may comprise at least one of (a) paint or printing on an inner surface of the cover; (b) paint or printing on an outer surface of each inner layer; (c) paint or printing on an inner surface of each inner layer. The component may comprise a functional layer; the functional layer may comprise at least one of (a) a sensor; (b) a capacitive layer. The component may comprise indicia aligned with the functional layer on at least one of (a) an inner surface of the cover; (b) a surface of each inner layer.

The present invention relates to a vehicle interior component configured for illumination by a light source comprising a composite structure comprising (a) a cover and (b) a base and (c) an intermediate layer between the cover and the base. The cover may comprise a surface and a cover layer comprising a glass material. The base may comprise a substrate. The composite structure may be configured to provide a visual effect. The intermediate layer may comprise a first reflective layer and an inner layer and a second reflective layer. Transmittance and reflectance of the first reflective layer may be selected to produce a substantially reflective surface. Reflectance of the second reflective layer may be selected to provide a mirror effect into the inner layer. The mirror effect may comprise a substantially full mirror effect. Transmittance and reflectance of the first reflective layer and the second reflective layer may be selected to produce a depth effect. Transmittance and reflectance of the first reflective layer and the second reflective layer may be selected to enhance intensity of reflected light within the layer. The depth effect may be produced from transmitted illumination and reflected illumination within the intermediate layer. The depth effect may comprise a repeated visual effect of a pattern. The inner layer may comprise a glass material; the glass material may comprise a thin glass. The composite structure may comprise a low-mass structure. The glass material may comprise a chemically-strengthened glass. The glass material may comprise an alumina-silica glass. The glass material may comprise a substantially iron-free glass. The composite structure may comprise a compact construction. The first reflective layer may comprise a one-way mirror coating. The second reflective layer may comprise an element. The second reflective layer may comprise a pattern. Illumination from the light source may be reflected between the first reflective layer and the second reflective layer to present a visual effect. The visual effect may comprise the pattern. The visual effect may comprise a depth effect. The depth effect may comprise an infinity effect. The infinity effect may comprise a reflection effect. The reflection effect may comprise the pattern. The light source may comprise a back light. The light source may comprise a side light at the intermediate layer. Illumination from the back light enhances the depth effect. Illumination from the side light may enhance the depth effect. The intermediate layer may be configured so that the depth effect is lengthened with distance between the first reflective layer and the second reflective layer. The depth effect may be modified by distance between the first reflective coating and the second reflective coating. The second reflective coating may comprise a full mirror with apertures to permit transmission of illumination. The first reflective coating may comprise a one-way mirror. The first reflective layer may comprise a treatment. The second reflective layer may comprise a treatment. The treatment may comprise a coating. The composite structure may comprise a safety film layer. The intermediate layer may comprise a laminate layer. The intermediate layer may comprise a safety coating. The intermediate layer may comprise an element between the first reflective layer and the second reflective layer. The element may comprise an object. The cover may comprise a glass layer and a lamination film; the intermediate layer may comprise a first inner glass layer and a treatment comprising a first reflective coating and a lamination film and a second inner glass layer and a treatment comprising a second reflective coating and a safety film; the light source may comprise a back light.

The present invention relates to a vehicle interior component manufactured by a process comprising the steps of: forming a composite structure comprising a cover and a base and an intermediate layer between the cover and the base; applying a treatment to the intermediate layer; and applying a film configured to hold the cover together when broken. The treatment may comprise at least one of (a) a decorative effect; (b) a coating; (c) printing; (d) paint.

The present invention relates to a vehicle interior component manufactured by a process comprising the steps of: forming a generally clear cover; forming a generally clear inner layer; printing a film; joining the printed film to each inner layer with an optically clear adhesive; joining the cover, each inner layer with the printed film and a base. The film may be configured to hold the cover together when broken; the film may comprise at least one of (a) a decorative effect; (b) a coating; (c) printing; (d) paint configured to at least one of (1) block light; (2) transmit light; (3) diffuse light. The step of joining the cover to each inner layer may comprise laminating the cover to each inner layer with at least one of (a) a cast resin; (b) a film. The step of forming the cover may comprise at least one of (a) cutting the cover; (b) treating at least one edge of the cover; (c) deforming a planar surface of the cover into a nonplanar surface of the cover. The component may comprise at least one of (a) paint or printing on an inner surface of the cover; (b) paint or printing on an outer surface of each inner layer; (c) paint or printing on an inner surface of each inner layer. The process may comprise a step of treating an outer surface of the cover.

The present invention relates to a vehicle interior component comprising a cover; a film coupled to the cover; and a base. The cover may be configured to allow light to pass through the cover. The cover may comprise a nonplanar surface. The film may be configured to hold the cover together when broken. The film may comprise at least a portion configured to block light. The film may comprise at least one of (a) a decorative effect; (b) a coating; (c) printing; (d) paint. The film may be coupled to the cover by at least one of (a) vacuum; (b) pressure; (c) heat; (d) light. The component may comprise a light source configured to provide light intended to be visible to an occupant in the vehicle when the component is in operation after installation in the interior of the vehicle. The film may comprise a substantially opaque portion and a substantially transparent portion; the substantially opaque portion may be configured to block light from the light source to prevent light from the light source to pass through an inner surface of the cover toward an outer surface of the cover. The cover may comprise an outer surface configured to present a user interface using light from the light source. The component may comprise a sensor configured for interaction at the outer surface of the cover. The cover may comprise glass. The glass of the cover may comprise a generally uniform thickness of between 0.3 mm and 1.5 mm. The cover may comprise an outer surface; the outer surface of the glass may comprise a treated surface. The treated surface may comprise at least one of (a) an etched surface; (b) a sand-blasted surface; (c) a scribed surface; (d) a laser scribed surface; (e) a surface configured to provide a haptic appearance. The cover may comprise an inner surface; the inner surface of the cover may comprise at least one of (a) a coating; (b) an inkjet printing; (c) a screen printing; (d) a laser ablated coating; (e) indicia. The glass of the cover may comprise at least one of (a) tempered glass; (b) partially tempered glass; (c) chemically strengthened glass; (d) toughened glass; (e) thermally strengthened glass; (f) anti-reflective glass; (g) anti-glare glass. The component may comprise a functional layer; the functional layer may comprise at least one of (a) a sensor; (b) a capacitive layer.

The present invention relates to a vehicle interior component comprising a cover; an inner layer coupled to the cover; and a base coupled to the inner layer. The inner layer may be configured to allow light to pass through the cover. The inner layer may comprise at least one of (a) a light guide; (b) glass; (c) a laminate; (d) wood; (e) metal; (f) stone; (g) a fabric. The inner layer may be configured to provide a depth effect. The component may comprise a film coupled to the inner layer; the film may be configured to hold at least one of (a) the cover; (b) the inner layer together when broken. The film may comprise at least a portion configured to block light. The film may comprise a decorative coating/printing. The film may be configured to provide a decorative effect. The component may comprise a bonding component configured to join the cover and the inner layer. The bonding component may comprise at least one of (a) a lamination film; (b) a cast resin; (c) a foil. The component may comprise at least one of (a) paint or printing on an inner surface of the cover; (b) paint or printing on an outer surface of the inner layer; (c) paint or printing on an inner surface of the inner layer. The component may comprise a functional layer; the functional layer may comprise at least one of (a) a sensor; (b) a capacitive layer. The component may comprise indicia aligned with the functional layer on at least one of (a) an inner surface of the cover; (b) a surface of the inner layer.

The present invention relates to a vehicle interior component manufactured by a process comprising the steps of forming a cover comprising glass; printing a film; joining the printed film to the cover with an optically clear adhesive; and joining the cover to a base. The film may be configured to hold the cover together when broken. The film may comprise at least one of (a) a decorative effect; (b) a coating; (c) printing; (d) paint.

The present invention relates to a vehicle interior component manufactured by a process comprising the steps of forming a generally clear cover; forming a generally clear inner layer; printing a film; joining the printed film to the inner layer with an optically clear adhesive; and joining the cover, the inner layer with the printed film and a base. The film may be configured to hold the cover together when broken; the film may comprise at least one of (a) a decorative effect; (b) a coating; (c) printing; (d) paint configured to at least one of (1) block light; (2) transmit light; (3) diffuse light. The step of joining the cover to the inner layer may comprise laminating the cover to the inner layer with at least one of (a) a cast resin; (b) a film. The step of forming the cover may comprise at least one of (a) cutting the cover; (b) treating at least one edge of the cover; (c) deforming a planar surface of the cover into a nonplanar surface of the cover. The component may comprise at least one of (a) paint or printing on an inner surface of the cover; (b) paint or printing on an outer surface of the inner layer; (c) paint or printing on an inner surface of the inner layer. The process may comprise a step of treating an outer surface of the cover.

### FIGURES

FIG. 1A is a schematic perspective view of a vehicle according to an exemplary embodiment.

FIG. 1B is a schematic perspective cut-away view of a vehicle showing an interior according to an exemplary embodiment.

FIG. 1C is a schematic perspective view of a vehicle door according to an exemplary embodiment.

FIGS. 2A to 2F are schematic perspective views of vehicle interior components according to an exemplary embodiment.

FIGS. 3, 4, 5, 6, 7, 8, 9, 10 and 11 are schematic exploded perspective views of vehicle interior components according to an exemplary embodiment.

FIGS. 12A to 12C are schematic partial section views of vehicle interior components according to an exemplary embodiment.

FIGS. 12D to 12E are schematic partial exploded section views of vehicle interior components according to an exemplary embodiment.

FIG. 13A is a schematic partial section view of a vehicle interior component according to an exemplary embodiment.

FIG. 13B is a schematic partial perspective view of a vehicle interior component according to an exemplary embodiment.

FIG. 13C is a schematic partial perspective view of a vehicle interior component according to an exemplary embodiment.

FIG. 13D is a schematic partial exploded perspective view of a vehicle interior component according to an exemplary embodiment.

FIG. 14A is a schematic partial section view of a vehicle interior component according to an exemplary embodiment.

FIG. 14B is a schematic partial exploded section view of a vehicle interior component according to an exemplary embodiment.

FIG. 14C is a schematic partial exploded perspective view of a vehicle interior component according to an exemplary embodiment.

FIG. 15A is a schematic partial perspective view of a vehicle interior component according to an exemplary embodiment.

FIG. 15B is a schematic partial exploded perspective view of a vehicle interior component according to an exemplary embodiment.

FIG. 15C is a schematic partial section view of a vehicle interior component according to an exemplary embodiment.

FIG. 15D is a schematic partial perspective view of a vehicle interior component according to an exemplary embodiment.

FIG. 15E is a schematic partial section view of a vehicle interior component according to an exemplary embodiment.

FIG. 15F is a schematic partial perspective view of a vehicle interior component according to an exemplary embodiment.

FIG. 15G is a schematic partial section view of a vehicle interior component according to an exemplary embodiment.

FIG. 15H is a schematic partial perspective view of a vehicle interior component according to an exemplary embodiment.

FIG. 15I is a schematic partial section view of a vehicle interior component according to an exemplary embodiment.

FIG. 15J is a schematic partial perspective view of a vehicle interior component according to an exemplary embodiment.

FIG. 15K is a schematic partial section view of a vehicle interior component according to an exemplary embodiment.

FIG. 15L is a schematic partial perspective view of a vehicle interior component according to an exemplary embodiment.

FIG. 16A is a schematic partial section view of a vehicle interior component according to an exemplary embodiment.

FIG. 16B is a schematic partial perspective view of a vehicle interior component according to an exemplary embodiment.

FIG. 16C is a schematic partial section view of a vehicle interior component according to an exemplary embodiment.

FIG. 16D is a schematic partial perspective view of a vehicle interior component according to an exemplary embodiment.

FIG. 16E is a schematic partial section view of a vehicle interior component according to an exemplary embodiment.

FIG. 16F is a schematic partial perspective view of a vehicle interior component according to an exemplary embodiment.

FIG. 17A is a schematic partial exploded perspective view of a vehicle interior component according to an exemplary embodiment.

FIG. 17B is a schematic partial perspective view of a vehicle interior component according to an exemplary embodiment.

FIG. 17C is a schematic partial section view of a vehicle interior component according to an exemplary embodiment.

FIG. 18A is a schematic partial section view of a vehicle interior component according to an exemplary embodiment.

FIG. 18B is a schematic partial exploded perspective view of a vehicle interior component according to an exemplary embodiment.

FIG. 19A is a schematic partial perspective view of a vehicle interior component according to an exemplary embodiment.

FIG. 19B is a schematic partial section view of a vehicle interior component according to an exemplary embodiment.

FIG. 19C is a schematic partial perspective view of a vehicle interior component according to an exemplary embodiment.

FIG. 19D is a schematic partial perspective view of a vehicle interior component according to an exemplary embodiment.

FIG. 19E is a schematic partial exploded perspective view of a vehicle interior component according to an exemplary embodiment.

FIGS. 20A to 20D are schematic perspective views of vehicle interior components according to an exemplary embodiment.

FIGS. 21A to 21C are schematic perspective views of vehicle interior components according to an exemplary embodiment.

FIGS. 22A to 22B are schematic perspective views of vehicle interior components according to an exemplary embodiment.

FIGS. 23A to 23C are schematic perspective views of vehicle interior components according to an exemplary embodiment.

FIG. 24A is a schematic partial perspective view of a vehicle interior component according to an exemplary embodiment.

FIG. 24B is a schematic partial section view of a vehicle interior component according to an exemplary embodiment.

FIG. 24C is a schematic partial exploded perspective view of a vehicle interior component according to an exemplary embodiment.

FIGS. 25A to 25C are schematic flow diagrams of methods for manufacturing a vehicle interior component according to an exemplary embodiment.

FIGS. 26A to 26C are schematic flow diagrams of methods for manufacturing a vehicle interior component according to an exemplary embodiment.

FIG. 27 is a schematic flow diagram of a method for manufacturing a vehicle interior component according to an exemplary embodiment.

### DESCRIPTION

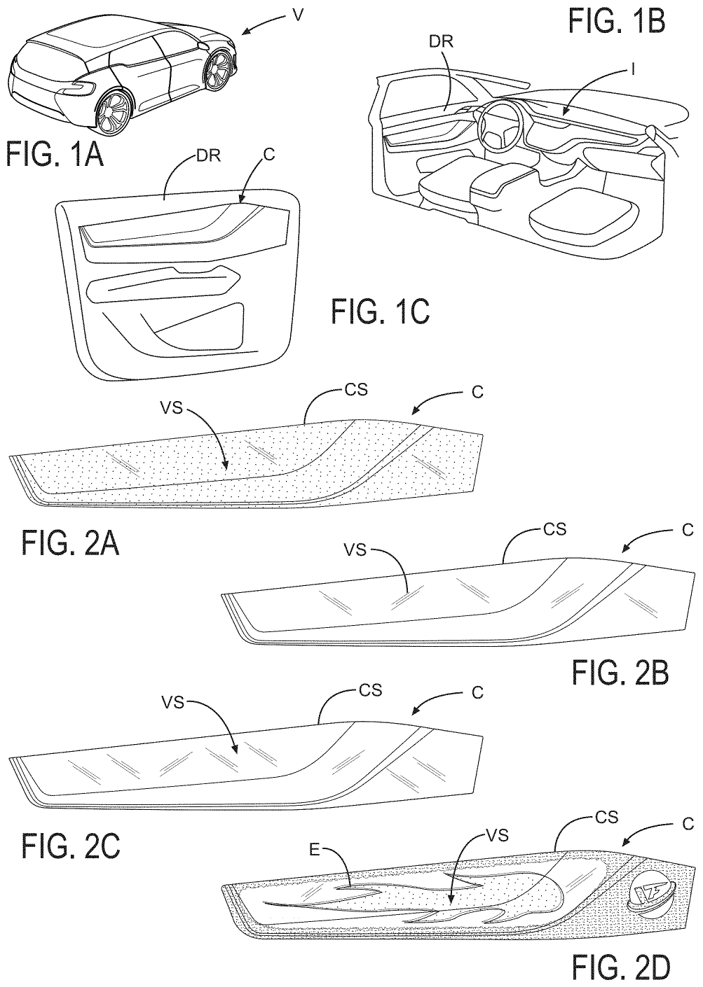

Referring to FIGS. 1A and 1B a vehicle V providing a vehicle interior I with a door D providing a door panel is shown according to an exemplary embodiment. As shown schematically in FIG. 1C, door D may comprise interior trim including a vehicle interior component C. As shown schematically in FIGS. 1D through 1G, component C may provide an ornamental design/visible effect/decorative image.

According to an exemplary embodiment as shown schematically in FIGS. 1B-1C, 2A-2F, 20A-20D, 21A-21C, 22A-22B and 23A-23B, the component C may comprise a composite structure CS configured to provide a variety of visual effects VS including a decorative effect and/or presentation of indicia IN and/or visible element E.

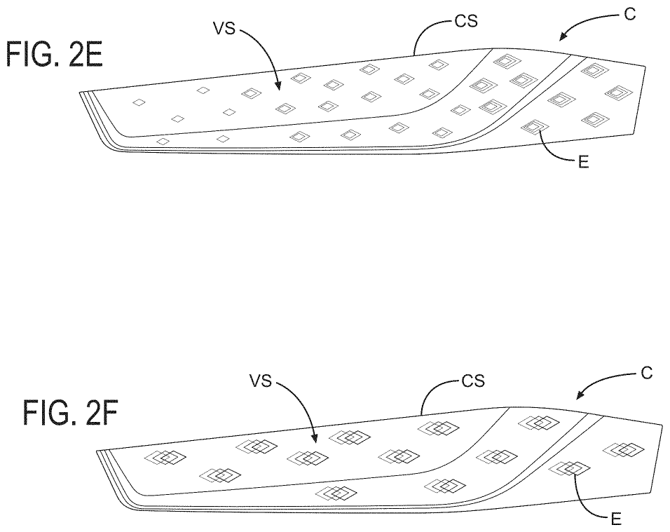

According to an exemplary embodiment as shown schematically in FIGS. 2A-2F, a vehicle interior component C may comprise a base/carrier/substrate B and a cover T. Cover T may comprise paint/printing P on an inner surface of the cover. A film or safety film SF may be adhered to the inner surface of the cover after paint/printing P has been applied to the inner surface of the cover. An adhesive A may be configured to join the cover and base B. Cover T may comprise glass. Cover T may comprise at least one of (a) tempered glass; (b) partially tempered glass; (c) chemically strengthened glass; (d) toughened glass; (e) thermally strengthened glass; (f) anti-reflective glass; (g) anti-glare glass. Cover T may comprise a thickness of not more than 1.5 mm Cover T may comprise at least one of (a) inkjet printing; (b) screen printing; (c) enamel printing; (d) a sand blasted surface; (e) an etched surface; (f) a depression; (g) a milled surface; (h) a coating; (i) an inlay; (j) a coating; (k) an anti-fingerprint coating; (l) scribing; (m) a haptic appearance. Safety film SF may be joined to the cover by a process using vacuum, pressure and heat. Safety film SF may comprise a generally flat sheet; the cover may comprise a three-dimensional shape. The process of joining safety film SF to the cover may form safety film to conform to the three-dimensional shape of the cover. Safety film SF may be configured to hold the cover together when cover is broken during use. Safety film SF may be configured to provide a decorative effect for vehicle interior component C. Safety film SF may comprise at least a portion configured to reflect and/or block light. Safety film SF may comprise at least one of (a) a textured surface; (b) a decorative coating; (c) printing. Adhesive A may be configured to accommodate differing rates of thermal expansion of the cover and base B; as base B and the cover expand at differing rates, adhesive A may prevent breakage or warpage of the cover. Base B may comprise an injection molded plastic. Component C may be manufactured by a process comprising the steps of forming the cover; printing film SF; joining printed film SF to the cover with optically clear adhesive OCA; and joining the cover to base B.

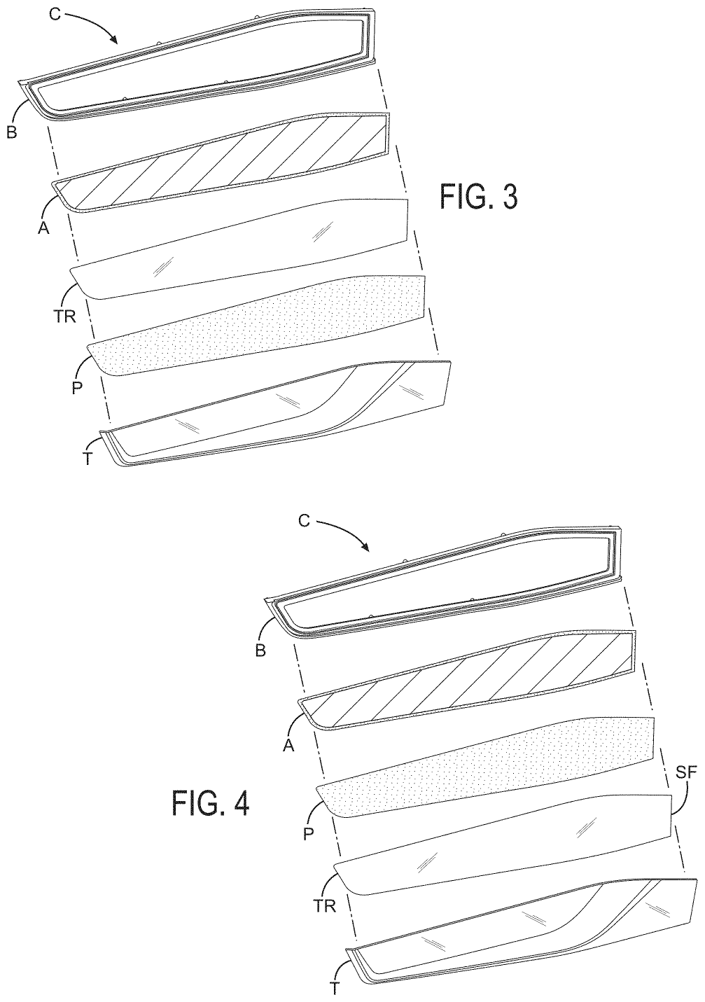

According to an exemplary embodiment as shown schematically in FIG. 3, a vehicle interior component C may comprise a base/carrier/substrate B and a cover T. Cover T may comprise a treatment TR on an outer surface of the cover. A film or printed safety film PSF may be joined to an inner surface of the cover by an optically clear adhesive OCA. An adhesive A may be configured to join the cover and base B. Optically clear adhesive OCA may comprise at least one of (a) ethylene-vinyl acetate or EVA; (b) thermoplastic polyurethane or TPU; (c) thermoplastic polyolefin or TPO; (d) polyvinyl butyral or PVB; (e) liquid optically clear adhesive; (f) polyurethane or PUR. Optically clear adhesive OCA may comprise a thickness of not more than 0.2 mm Printed safety film PSF may comprise a thickness of not more than 0.25 mm.

According to an exemplary embodiment, vehicle interior component C may comprise a cover T; a film SF coupled to the cover; and a base B. Cover T may be configured to allow light to pass through the cover. Cover T may comprise a nonplanar surface. Film SF may be configured to hold the cover together when broken. Film SF may comprise at least a portion configured to block light. Film SF may comprise at least one of (a) a decorative effect; (b) a coating; (c) printing; (d) paint. Film SF may comprise a paint configured to at least one of (1) block light; (2) transmit light; (3) diffuse light. Film SF may be coupled to the cover by at least one of (a) vacuum; (b) pressure; (c) heat; (d) light. Component C may comprise a light source configured to provide light intended to be visible to an occupant in the vehicle when component C is in operation after installation in the interior of the vehicle. Film SF may comprise a substantially opaque portion and a substantially transparent portion; the substantially opaque portion may be configured to block light from the light source to prevent light from the light source to pass through an inner surface of the cover toward an outer surface of the cover. Cover T may comprise an outer surface configured to present a user interface using light from the light source. Component C may comprise a sensor configured for interaction at the outer surface of the cover. Cover T may comprise glass. The glass of the cover may comprise a generally uniform thickness of between 0.3 mm and 1.5 mm Cover T may comprise an outer surface; the outer surface of the glass may comprise a treated surface. The treated surface may comprise at least one of (a) an etched surface; (b) a sand-blasted surface; (c) a scribed surface; (d) a laser scribed surface; (e) a surface configured to provide a tactile/haptic appearance. Cover T may comprise an inner surface; the inner surface of the cover may comprise at least one of (a) a coating; (b) an inkjet printing; (c) a screen printing; (d) a laser ablated coating; (e) indicia. The glass of the cover may comprise at least one of (a) tempered glass; (b) partially tempered glass; (c) chemically strengthened glass; (d) toughened glass; (e) thermally strengthened glass; (f) anti-reflective glass; (g) anti-glare glass. Component C may comprise a functional layer; the functional layer may comprise at least one of (a) a sensor; (b) a capacitive layer.

According to an exemplary embodiment as shown schematically in FIG. 4, a vehicle interior component C may comprise a base/carrier/substrate B, an inner layer IL and a cover T. A film or printed safety film PSF may be joined to an inner surface of inner layer IL by an optically clear adhesive OCA. IL with printed safety film PSF may be joined to the cover by a bonding component L. An adhesive A may be configured to join the cover and inner layer IL with printed safety film PSF to base B. Inner layer IL may comprise glass. Inner layer IL may comprise a light guide. Inner layer IL may comprise at least one of (a) a laminate; (b) wood; (c) metal; (d) stone; (e) a fabric. Inner layer IL and the cover may provide a depth effect for interior component C. Bonding component L may comprise at least one of (a) a lamination film; (b) a cast resin; (c) a foil. Component C may be manufactured by a process comprising the steps of forming the cover; forming inner layer IL; printing safety film PSF; joining printed safety film PSF to inner layer IL with optically clear adhesive OCA; and joining cover C, inner layer IL with printed safety film PSF and base B. The step of joining the cover to inner layer IL may comprise laminating the cover to inner layer IL with at least one of (a) a cast resin; (b) a film. The step of forming the cover may comprise at least one of (a) cutting the cover; (b) treating at least one edge of the cover; (c) deforming a planar surface of the cover into a nonplanar surface of the cover. The process may comprise a step of treating an outer surface of the cover.

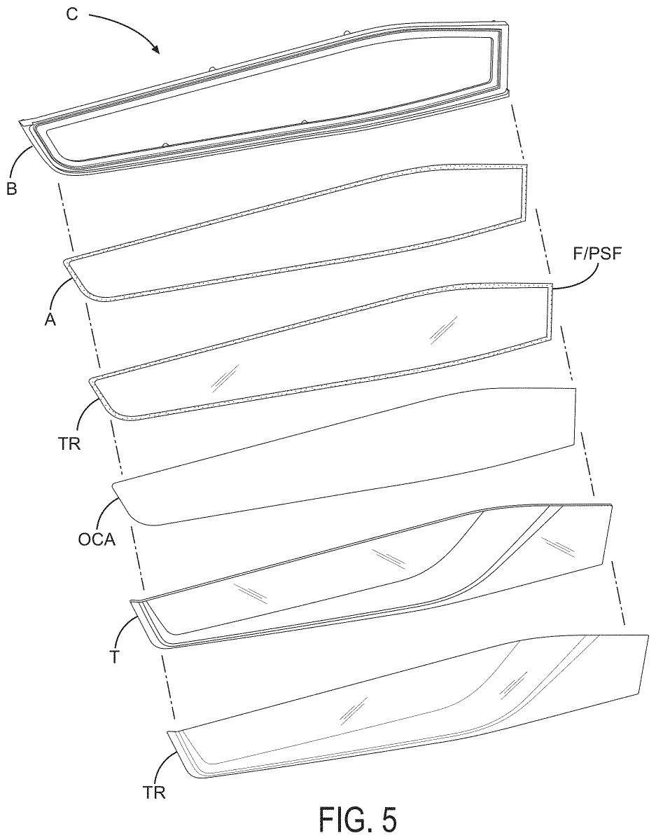

According to an exemplary embodiment as shown schematically in FIG. 5, a vehicle interior component C may comprise a base/carrier/substrate B, a decorative insert DI and a cover T. Cover T may comprise paint/printing P on an inner surface of the cover. A printed cover PC may comprise the cover T and the paint/printing P. Decorative insert DI may comprise an inner layer comprising paint/printing P on an inner surface and/or an outer surface of inner layer IL. A film or printed safety film PSF may be joined to an inner surface of inner layer IL by an optically clear adhesive OCA. IL with paint/printing P and with printed safety film PSF may be joined to printed cover PC by a bonding component L. An adhesive A may be configured to join printed cover PC and inner layer IL with paint/printing P and with printed safety film PSF to base B. Vehicle interior component may further comprise at least one light source LS and at least one functional layer S. Cover T may comprise an outer surface configured to present a user interface using light from light source LS. Printed safety film PSF may comprise a substantially opaque portion and a substantially transparent portion; the substantially opaque portion may be configured to block light from light source LS to prevent light from light source LS to pass through an inner surface of the cover toward an outer surface of the cover. Functional layer S may be configured for interaction at the outer surface of the cover. Functional layer S may comprise at least one of (a) a sensor; (b) a capacitive layer.

According to an exemplary embodiment, vehicle interior component C may comprise a cover T; an inner layer IL coupled to the cover; and a base B coupled to inner layer IL. Inner layer IL may be configured to allow light to pass through the cover. Inner layer IL may comprise at least one of (a) a light guide; (b) glass. Inner layer IL may be configured to provide a depth effect. Component C may comprise a film F/PSF coupled to inner layer IL; film F/PSF may be configured to hold at least one of (a) the cover; (b) inner layer IL together when broken. Film F/PSF may comprise at least a portion configured to block light. Film F/PSF may comprise a decorative coating/printing. Film F/PSF may be configured to provide a decorative effect. The component may comprise a bonding component L configured to join the cover and inner layer IL. Bonding component L may comprise at least one of (a) a lamination film; (b) a cast resin; (c) a foil. Component C may comprise at least one of (a) paint or printing on an inner surface of the cover; (b) paint or printing on an outer surface of inner layer IL; (c) paint or printing on an inner surface of inner layer IL. Component C may comprise a functional layer S; functional layer S may comprise at least one of (a) a sensor; (b) a capacitive layer. Component C may comprise indicia shown as paint/printing P aligned with functional layer S on at least one of (a) an inner surface of the cover; (b) a surface of inner layer IL.

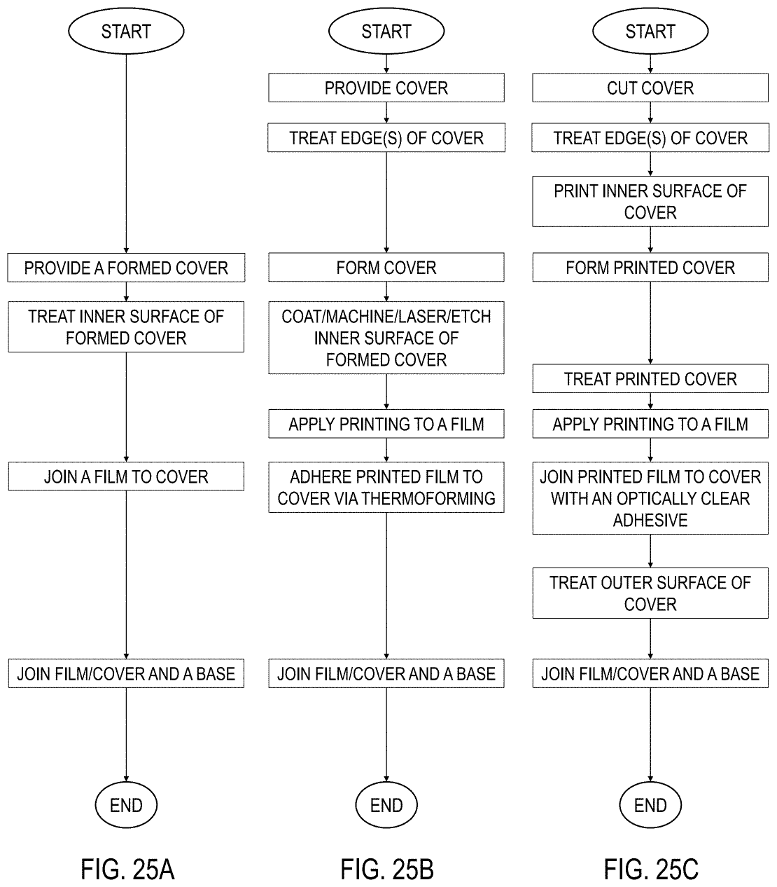

According to an exemplary embodiment as shown schematically in FIG. 25A, a vehicle interior component may be prepared by a process comprising providing a formed cover, treating an inner surface of the formed cover, joining a film to the cover and joining the film/cover and a base.

According to an exemplary embodiment as shown schematically in FIG. 25B, a vehicle interior component may be prepared by a process comprising providing a cover, treating at least one edge of the cover, forming the cover, coating/machining/lasering/etching an inner surface of the formed cover, applying printing to a film, adhering the printed film to the cover and joining the film/cover and a base.

According to an exemplary embodiment as shown schematically in FIG. 25C, a vehicle interior component may be prepared by a process comprising cutting a cover, treating at least one edge of the cover, printing an inner surface of the cover, forming the printed cover, treating the printed cover, applying printing to a film, joining the printed film to the cover with an optically clear adhesive, treating an outer surface of the cover and joining the film/cover and a base.

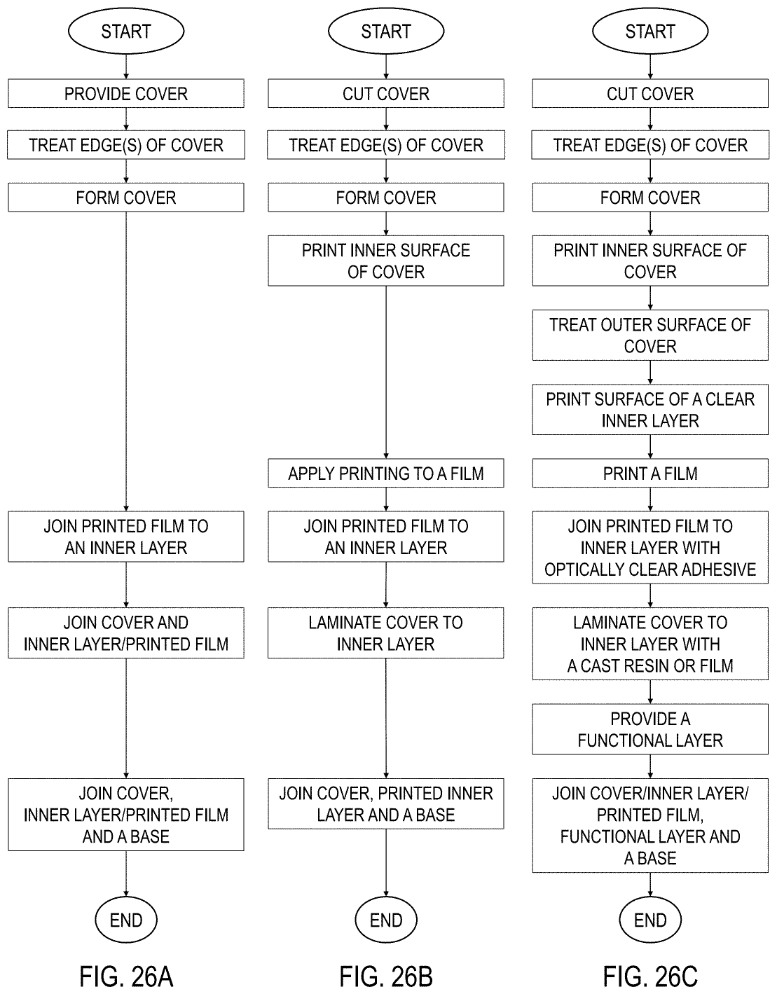

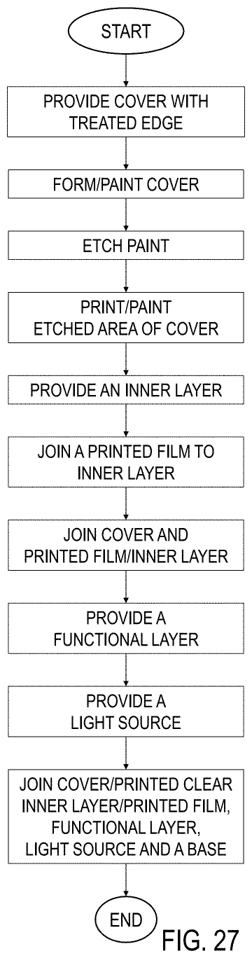

According to an exemplary embodiment as shown schematically in FIG. 26A, a vehicle interior component may be prepared by a process comprising providing a cover, treating at least one edge of the cover, forming the cover, joining a printed film to an inner layer, joining the cover and the inner layer/printed film and joining the cover, the inner layer/printed film and a base.

According to an exemplary embodiment as shown schematically in FIG. 26B, a vehicle interior component may be prepared by a process comprising cutting a cover, treating at least one edge of the cover, forming the cover, printing an inner surface of the cover, applying printing to a film, joining the printed film to an inner layer, laminating the cover to the inner layer and joining the cover, the printed inner layer and a base.

According to an exemplary embodiment as shown schematically in FIG. 26C, a vehicle interior component may be prepared by a process comprising cutting a cover, treating at least one edge of the cover, forming the cover, printing an inner surface of the cover, treating an outer surface of the cover, printing a surface of a generally clear inner layer, printing a film, joining the printed film to the inner layer with an optically clear adhesive, laminating the cover to the inner layer with a cast resin or film, providing a functional layer and joining the cover/inner layer/printed film, the functional layer and a base.

According to an exemplary embodiment as shown schematically in FIG. 27, a vehicle interior component may be prepared by a process comprising providing a cover with at least one treated edge, forming and painting the cover, etching at least a portion of the paint of the cover, printing/painting the etched area of the cover, providing an inner layer, joining a printed film to the inner layer, joining the cover and the printed film/inner layer, providing a functional layer, providing a light source, joining the cover/printed clear inner layer/printed film, the functional layer, the light source and a base.

### Exemplary Embodiments—A

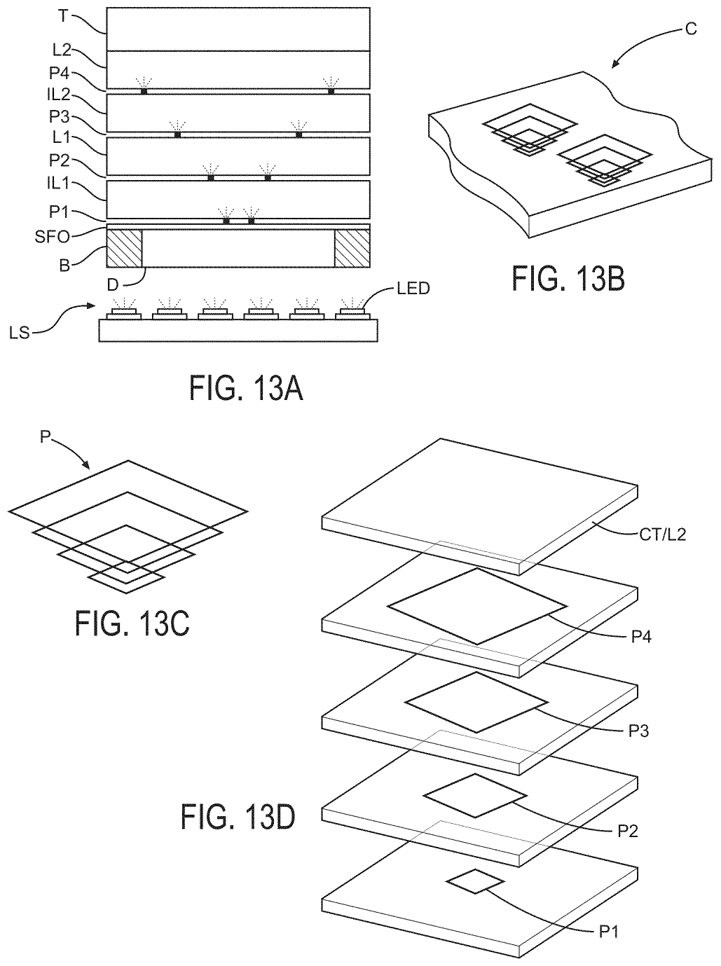

According to an exemplary embodiment as shown schematically in FIGS. 1B-1C, 2A-2F, 20A-20D, 21A-21C, 22A-22B and 23A-23B, the component C may comprise a composite structure CS configured to provide a variety of visual effects VS including a decorative effect and/or presentation of indicia IN and/or visible element E. As indicated schematically in FIGS. 2A-2D, the visual effect may comprise the decorative effect visible at the surface of the cover of the composite structure. As indicated schematically in FIGS. 2E-2F, 20A-20D, 21A-21C, 22A-22B and 23A-23B, the visual effect may comprise a composite visual effect at the surface of the cover of the composite structure (the composite visual effect may also comprise the decorative effect). As indicated schematically in FIGS. 2E-2F, 20A-20D, 21A-21C, 22A-22B and 23A-23B, the visual effect and/or composite visual effect may comprise an element or elements in pattern and/or may be augmented/presented by illumination from a light source for the component. See also FIGS. 13A, 14A, 15C, 15E, 15G, 15I and 15k.

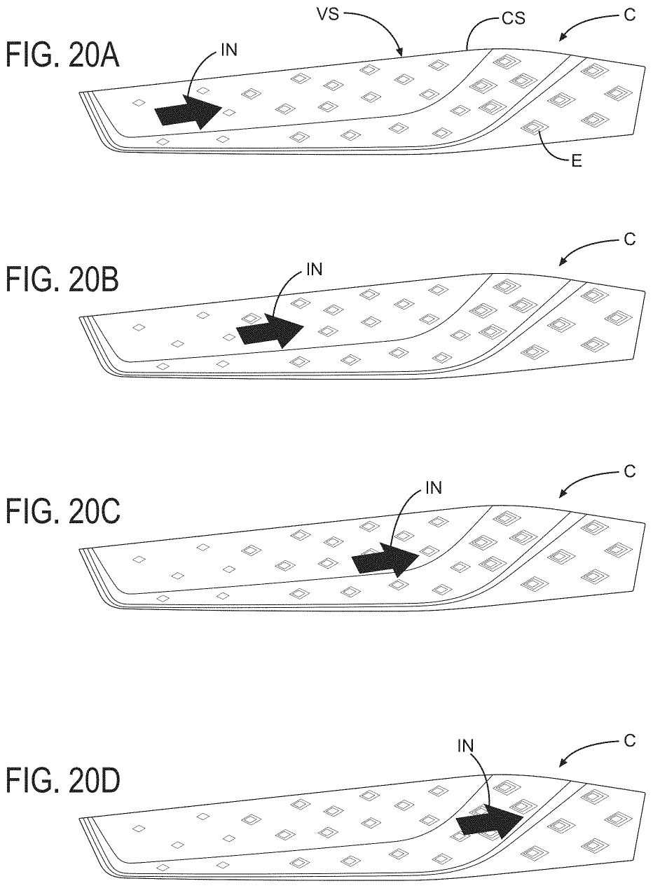

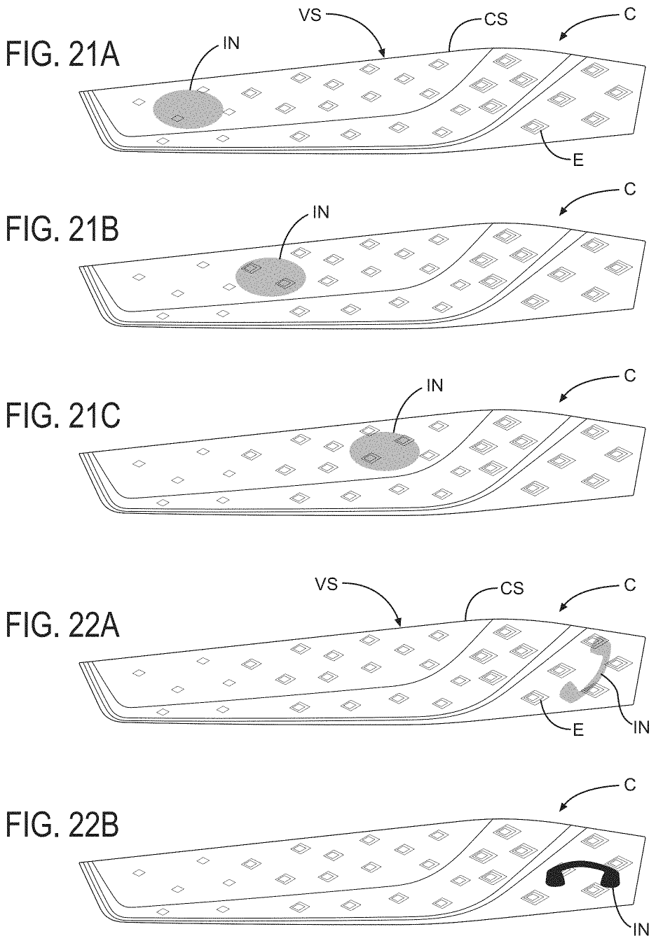

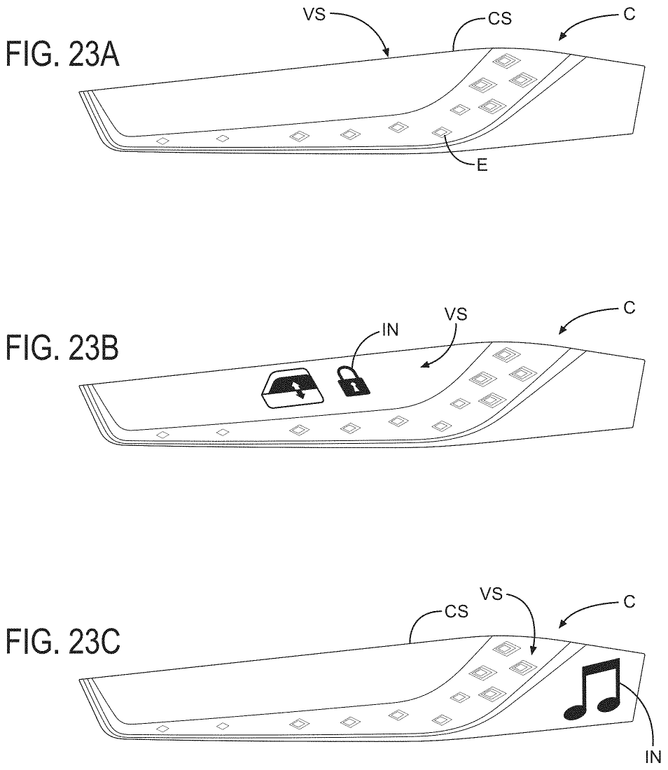

As indicated schematically in FIGS. 2E-2F, 20A-20D, 21A-21C, 22A-22B and 23A-23B, the composite visual effect may comprise a dynamic visual effect such as a depth effect (see FIGS. 2E-2F) or an indicator (see FIGS. 20A-20B) or an alert/signal (see FIGS. 21A-21C and 22A-22B) or instrumentation/messaging (see FIGS. 23A-23C). As indicated schematically, the visual effect and/or indicia may be presented for any of a variety of purposes including but not limited to a decorative purpose, for a user interface, for interaction with one or more vehicle systems, for communications/network connectivity, for interaction with systems/devices, etc. (and the indicia may comprise a moving effect/animation as indicated). See generally FIGS. 2A-2F, 20A-20D, 21A-21C, 22A-22B and 23A-23B. As indicated schematically, the visual effect of the illumination may comprise a variation of effects or composite visual effect; the composite visual effect may be a product of the manner of construction or of configuration and or operation of the composite structure and light source (e.g. intensity of illumination, animation of illumination, control of animation, etc.).

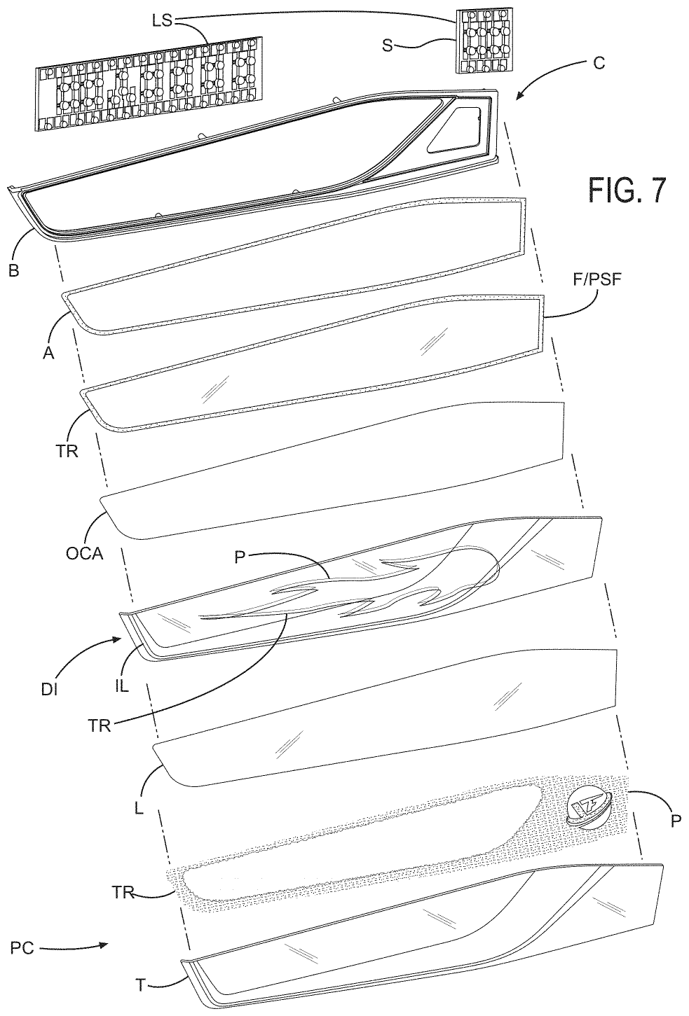

As indicated schematically according to an exemplary embodiment in FIGS. 2A-2F, 3, 4, 5, 6, 7, 8, 9, 10 and 11, the component may comprise a composite structure comprising a base B and a cover T and a variety of types/forms of intermediate layers (e.g. layers with treatments, coatings, surface effects, adhesives, bonding, inserts, films, printing, paint, etc.); the component may also be provided with a light source LS (or display panel DP) and/or a functional layer/system such as a sensor S. See FIGS. 7, 8 and 11. As indicated schematically in FIGS. 2A-2F, the composite structure of the component may be configured to provide a visual effect (e.g. presented by configuration and treatment/elements of the cover layer, intermediate layer, etc.); the visual effect may comprise a composite visual effect. As indicated schematically in FIGS. 2A-2F, 20A-20D, 21A-21C, 22A-22B and 23A-23B, the cover/cover layer may comprise a glass material (e.g. light transmissive material) configured to present a visual effect and/or to facilitate presentation of a visual effect at the intermediate layer and/or from illumination (e.g. base light, side light, etc.).

As indicated schematically according to an exemplary embodiment in FIG. 3, the composite structure of component C may comprise a base B with an intermediate layer comprising an adhesive A and a layer/treatment TR and a layer/print/paint P and cover T.

As indicated schematically according to an exemplary embodiment in FIG. 4, the composite structure of component C may comprise a base B with an intermediate layer comprising an adhesive A and layer/print/paint P a layer/treatment TR (comprising a safety film SF) and cover T.

As indicated schematically according to an exemplary embodiment in FIG. 5, the composite structure of component C may comprise a base B with an intermediate layer comprising an adhesive A and a layer/treatment TR (comprising a film/printed safety film F/PSF) and a layer/optically clear adhesive OCA and a cover T with treated cover/surface layer TR.

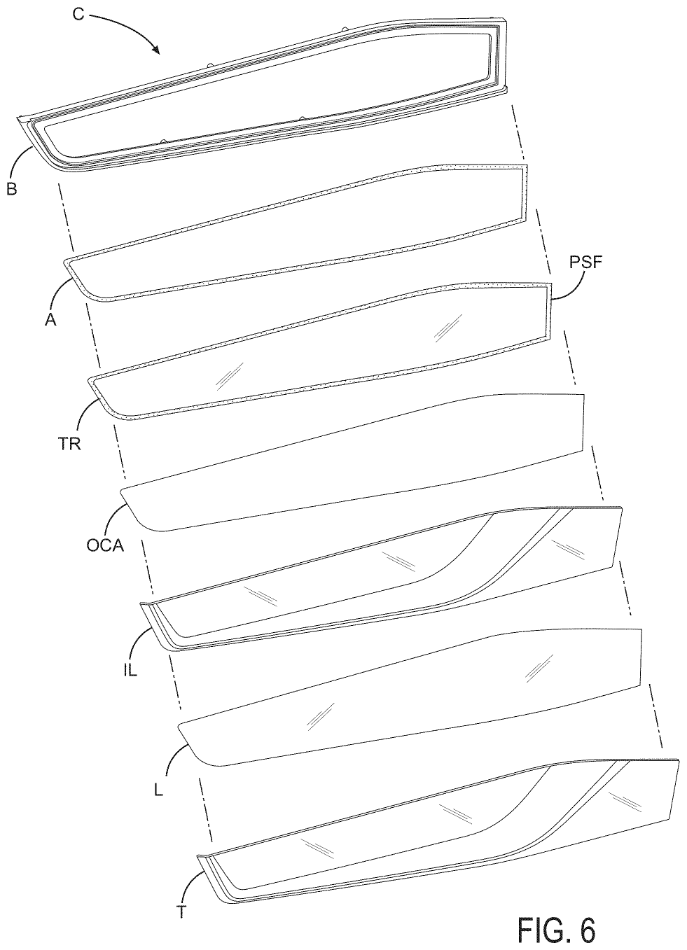

As indicated schematically according to an exemplary embodiment in FIG. 6, the composite structure of component C may comprise a base B with an intermediate layer comprising an adhesive A and a layer/treatment TR (comprising a printed safety film PSF) and a layer/optically clear adhesive OCA and an inner layer IL (such as a glass layer/material) and a layer/laminate L and cover T.

As indicated schematically according to an exemplary embodiment in FIG. 7, the composite structure of component C may comprise a base B with an intermediate layer comprising an adhesive A and a layer/treatment TR (comprising a film/printed safety film F/PSF) and a layer/optically clear adhesive OCA and a decorative insert DI and a layer/laminate L and a layer/treatment TR (comprising a paint/coating P) and cover T; as indicated schematically the decorative insert DI may comprise a inner layer IL (such as a glass layer/material) with a treatment TR (comprising a coating/paint P and light-transmissive sections) configured to provide a visual effect.

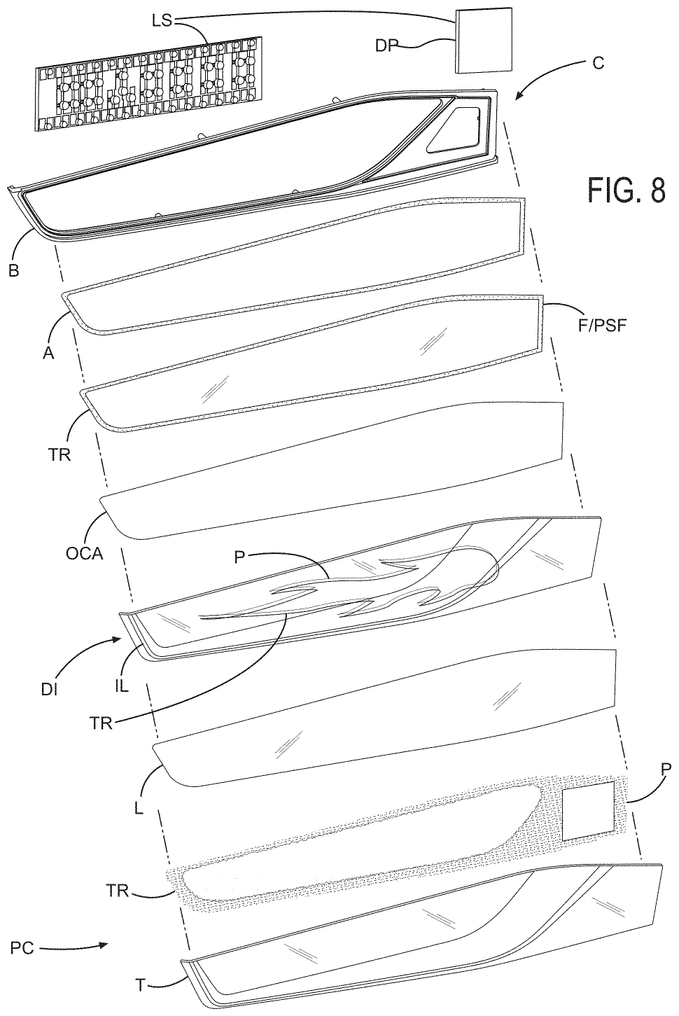

As indicated schematically according to an exemplary embodiment in FIG. 8, the composite structure of component C may comprise a base B with an intermediate layer comprising an adhesive A and a layer/treatment TR (comprising a film/printed safety film F/PSF) and a layer/optically clear adhesive OCA and a decorative insert DI and a layer/laminate L and a layer/treatment TR (comprising a paint/coating P) and cover T; as indicated schematically the decorative insert DI may comprise a inner layer IL (such as a glass layer/material) with a treatment TR (comprising a coating/paint P and light-transmissive sections) configured to provide a visual effect. As indicated schematically, a light source LS and display panel DP may be provided for the composite structure of the component (e.g. to present and or augment/illuminate a visual effect, composite visual effect, etc. for sections of the component). See FIGS. 20A-20D, 21A-21C, 22A-22B and 23A-23B.

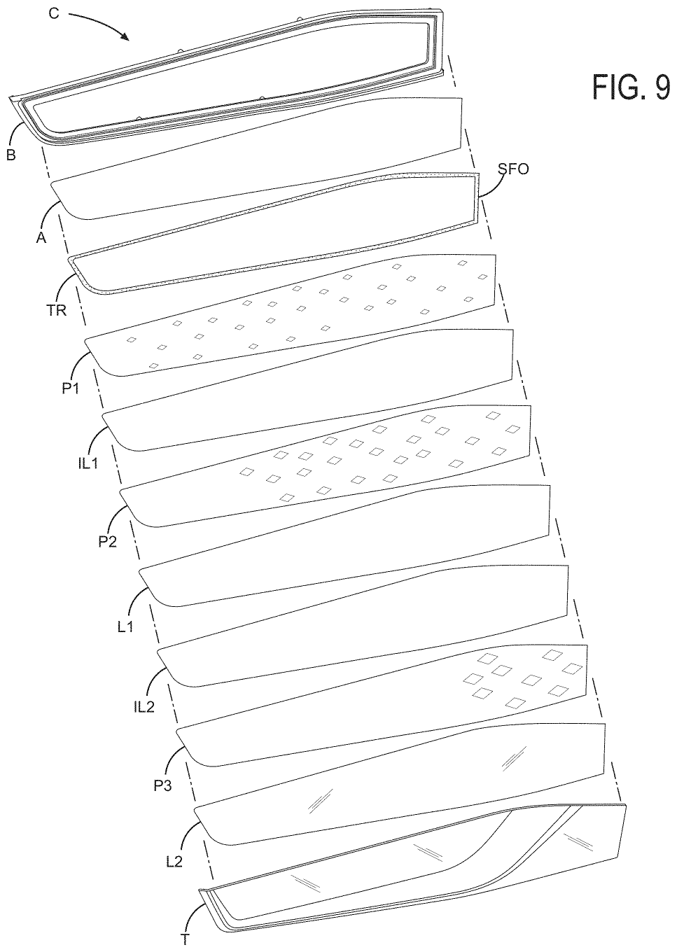

As indicated schematically according to an exemplary embodiment in FIG. 9, the composite structure of component C may comprise a base B with an intermediate layer comprising an adhesive A and a layer/treatment TR (comprising a safety film/optically clear adhesive SFO) and a layer/print/paint P1 (with elements for a visual effect) for surface of an inner layer IL1 (such as a glass layer/material) and a layer/print/paint P2 (with elements for a visual effect) for surface of the inner layer IL1 and a layer/laminate L1 and an inner layer IL2 (such as a glass layer/material) a layer/laminate L2 and a layer/print/paint P3 (with elements for a visual effect) and a layer/laminate L2 with cover T.

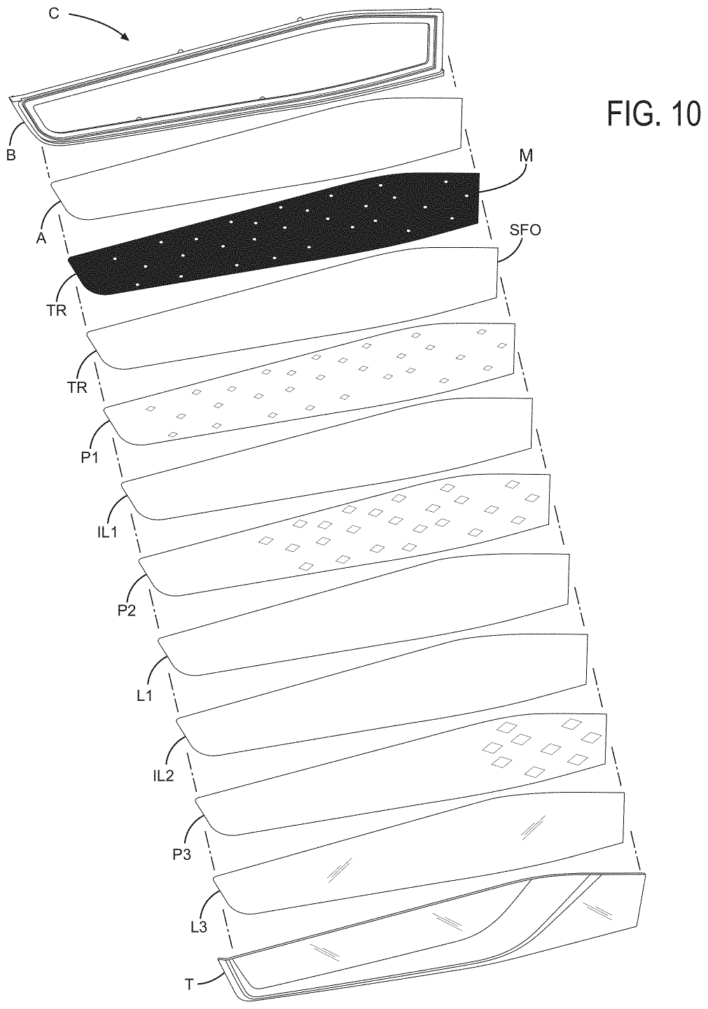

As indicated schematically according to an exemplary embodiment in FIG. 10, the composite structure of component C may comprise a base B with an intermediate layer comprising an adhesive A and a layer/treatment TR (comprising a mask layer M with apertures such as pinholes, etc.) and a layer/treatment TR (comprising a safety film/optically clear adhesive SFO) and a layer/print/paint P1 (with elements for a visual effect) for surface of an inner layer IL1 (such as a glass layer/material) and a layer/print/paint P2 (with elements for a visual effect) for surface of the inner layer IL1 and a layer/laminate L1 and an inner layer IL2 (such as a glass layer/material) a layer/laminate L2 and a layer/print/paint P3 (with elements for a visual effect) and a layer/laminate L2 with cover T. As indicated schematically according to an exemplary embodiment, the apertures (e.g. pinholes, etc.) of the treatment/mask layer M may be in registration/alignment with the elements of the print/paint/coating layers P1/P2/P3 (see FIG. 10) (such as to facilitate transmission of illumination to the elements through mask/apertures from a base light source).

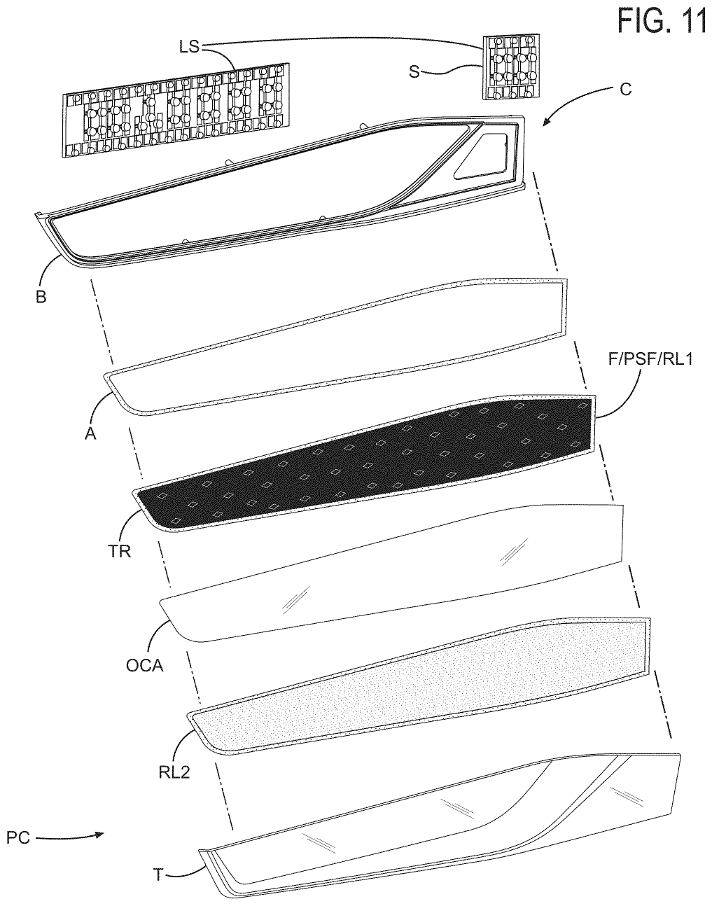

As indicated schematically according to an exemplary embodiment in FIG. 11, the composite structure of component C may comprise a base B with an intermediate layer comprising an adhesive A and a layer/treatment TR (comprising a film/paint/safety film/reflective layer F/PSF/RL1) and a layer/optically clear adhesive OCA and a layer/treatment (comprising a reflective layer RL2) with cover T; as indicated schematically, the reflective layer RL1 and reflective layer RL2 are configured to provide a mirror effect within the intermediate layer (e.g. so to provide a visual effect such as a depth/infinity effect for the composite structure).

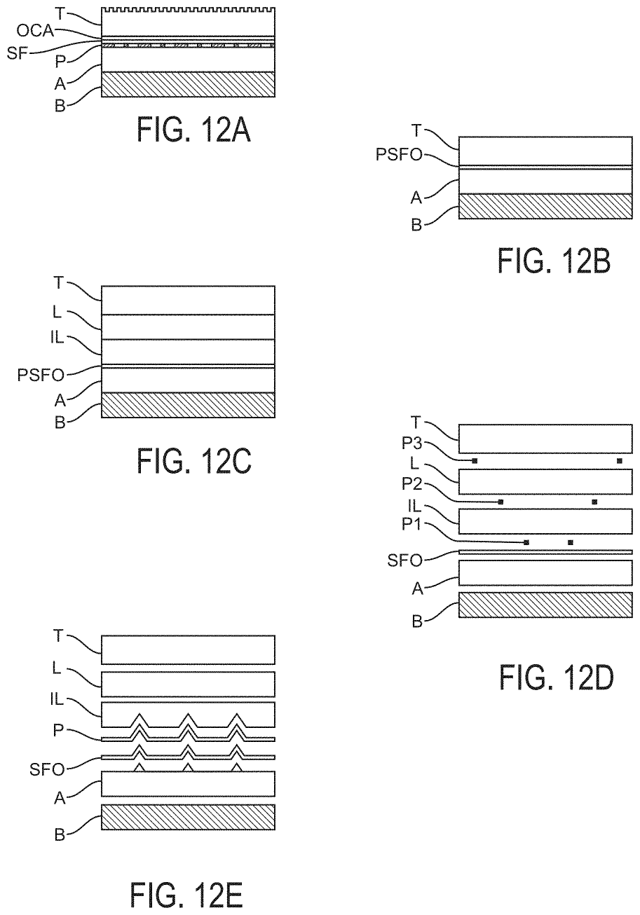

As indicated schematically according to an exemplary embodiment in FIG. 12A, the composite structure of the component may comprise a base B with an intermediate layer comprising an adhesive A and a layer/treatment comprising a coating/printing/paint P and a layer/safety film SF and a layer/optically clear adhesive OCA and cover T (with surface effect indicated for tactile effect).

As indicated schematically according to an exemplary embodiment in FIG. 12B, the composite structure of the component may comprise a base B with an intermediate layer comprising an adhesive A and a layer/treatment comprising a printed safety film/optically clear adhesive PSFO and cover T.

As indicated schematically according to an exemplary embodiment in FIG. 12C, the composite structure of component C may comprise a base B with an intermediate layer comprising an adhesive A and a layer/treatment comprising a printed safety film/optically clear adhesive PSFO and an inner layer IL and a layer/laminate L and cover T.

As indicated schematically according to an exemplary embodiment in FIG. 12D, the composite structure of the component may comprise a base B with an intermediate layer comprising an adhesive A and a layer/treatment comprising a safety film/optically clear adhesive SFO and a layer/print/paint P1 (with elements for a visual effect) for surface of an inner layer IL (such as a glass layer/material) and a layer/print/paint P2 (with elements for a visual effect) for surface of the inner layer IL1 and a layer/laminate L and a layer/print/paint P3 (with elements for a visual effect) and cover T; as indicated the elements may facilitate a visual effect for the composite structure (e.g. a depth effect, etc. within the composite structure).

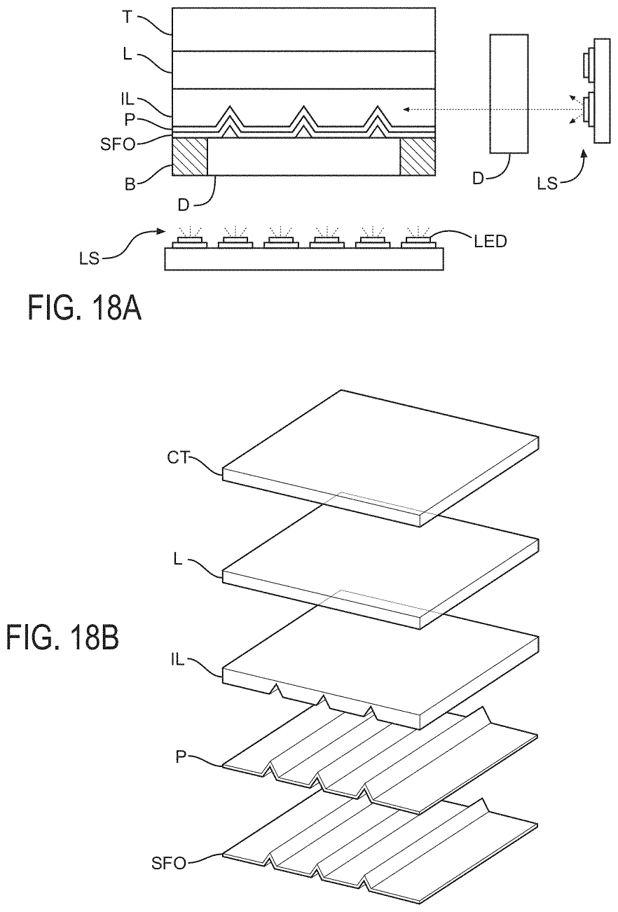

As indicated schematically according to an exemplary embodiment in FIG. 12E, the composite structure of the component may comprise a base B with an intermediate layer comprising an adhesive A and a layer/treatment comprising a safety film/optically clear adhesive SFO and a layer/print/paint P (with elements for a visual effect) for surface of an inner layer IL (such as a glass layer/material with treatment to provide elements shown as recesses) and a layer/laminate L with cover T; as indicated the treatment/elements may facilitate a visual effect for the composite structure (e.g. a depth effect, etc. within the composite structure). See also FIGS. 18A-18B (indicating component with light source shown as base light LS (to provide illumination through base B and diffuser D) and side light LS (in arrangement to provide selective illumination into inner layer IL).

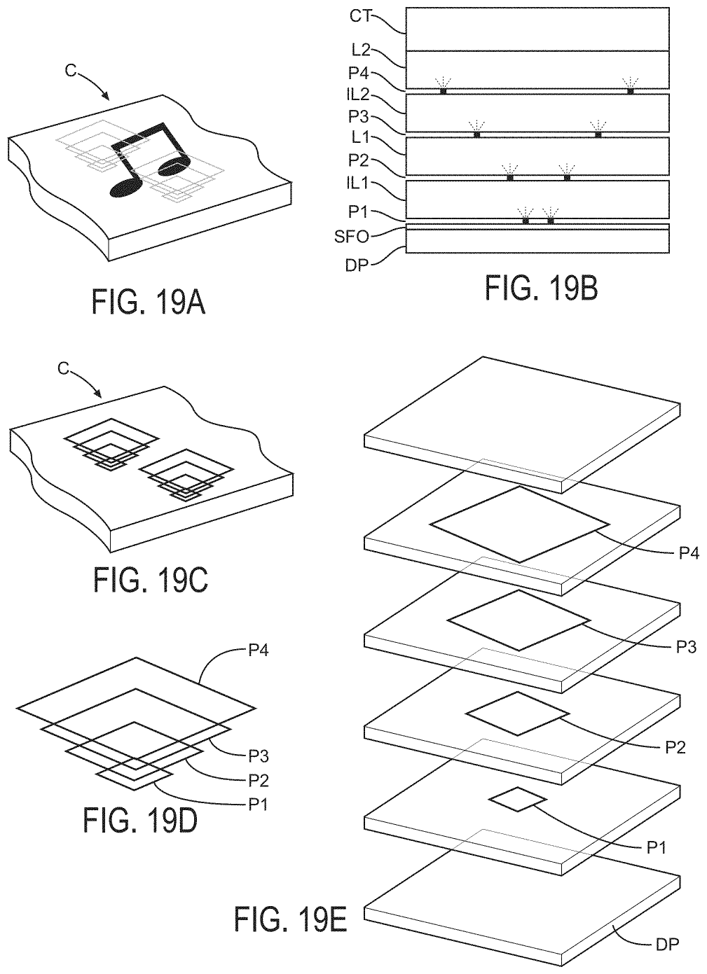

As indicated schematically according to an exemplary embodiment in FIGS. 13A-13D and 19A-19F, the composite structure of component C may comprise a base B with a diffuser D and an intermediate layer comprising a layer/treatment comprising a safety film/optically clear adhesive SFO and a layer/print/paint P1 (with elements for a visual effect) for surface of an inner layer IL1 (such as a glass layer/material) and a layer/print/paint P2 (with elements for a visual effect) for surface of the inner layer IL1 and a layer/laminate L1 and a layer/print/paint P3 (with elements for a visual effect) for surface of an inner layer IL2 (such as a glass layer/material) and a layer/print/paint P4 (with elements for a visual effect) for surface of the inner layer IL2 and a layer/laminate L2 with cover T. As indicated schematically according to an exemplary embodiment in FIG. 13A, a light source LS may comprise an LED arrangement/array configured as a base light to provide illumination into the diffuser (i.e. at the base of the composite structure) to present/augment a visual effect comprising elements from the treatment P (e.g. coating, print, paint, etc.) as indicated in FIGS. 13B and 13C. As indicated schematically according to an exemplary embodiment in FIGS. 19A-19F, the light source may comprise a display panel DP configured to provide illumination into the diffuser (i.e. at the base of the composite structure) to present/augment a visual effect comprising elements from the treatment P (e.g. coating, print, paint, etc.) as well as to present an image shown as indicia IN.

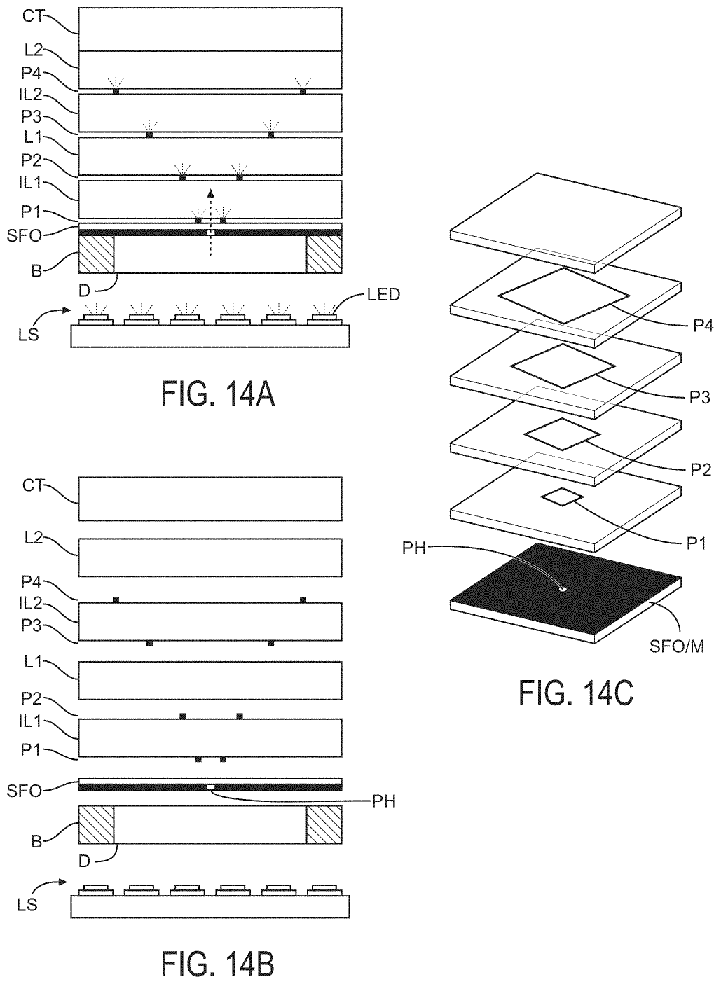

As indicated schematically according to an exemplary embodiment in FIGS. 14A-14C, the composite structure of component C may comprise a base B with a diffuser D and an intermediate layer comprising a layer/treatment comprising an opaque safety film SFO (within an aperture PH for light transmission from the diffuser) and a layer/print/paint P1 (with elements for a visual effect) for surface of an inner layer IL1 (such as a glass layer/material) and a layer/print/paint P2 (with elements for a visual effect) for surface of the inner layer IL1 and a layer/laminate L1 and a layer/print/paint P3 (with elements for a visual effect) for surface of an inner layer IL2 (such as a glass layer/material) and a layer/print/paint P4 (with elements for a visual effect) for surface of the inner layer IL2 and a layer/laminate L2 with cover T. As indicated schematically according to an exemplary embodiment in FIGS. 14A-14B, a light source LS may comprise an LED arrangement/array (or display panel) configured to provide illumination into the diffuser (i.e. at the base of the composite structure) through the aperture PH to present/augment a visual effect comprising elements from the treatment P (e.g. coating, print, paint, etc.). See also FIG. 14C.

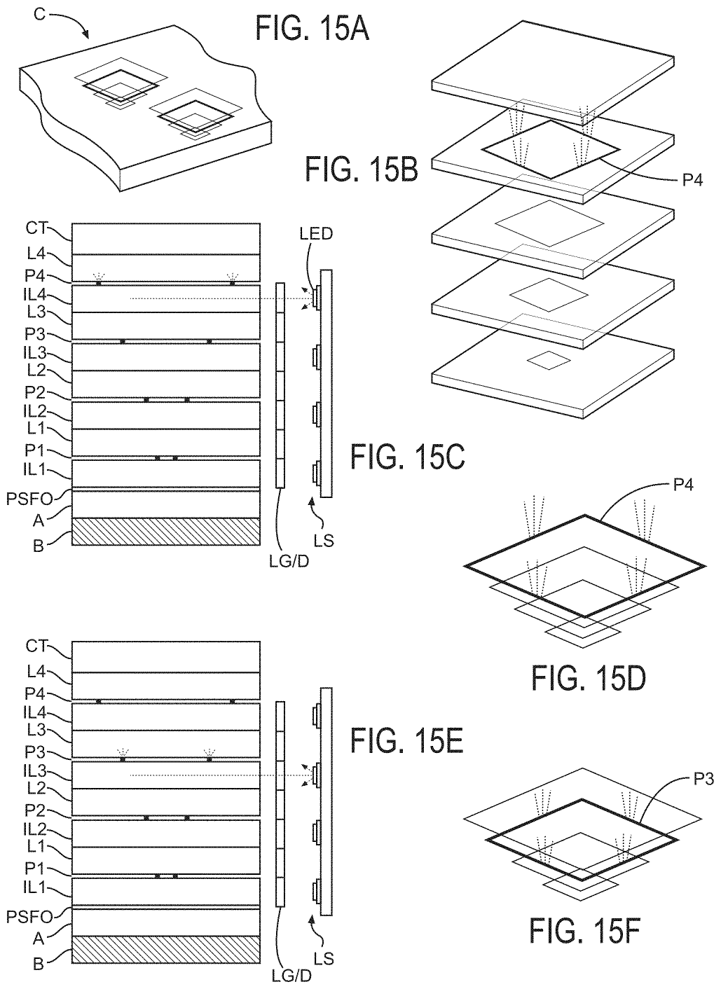

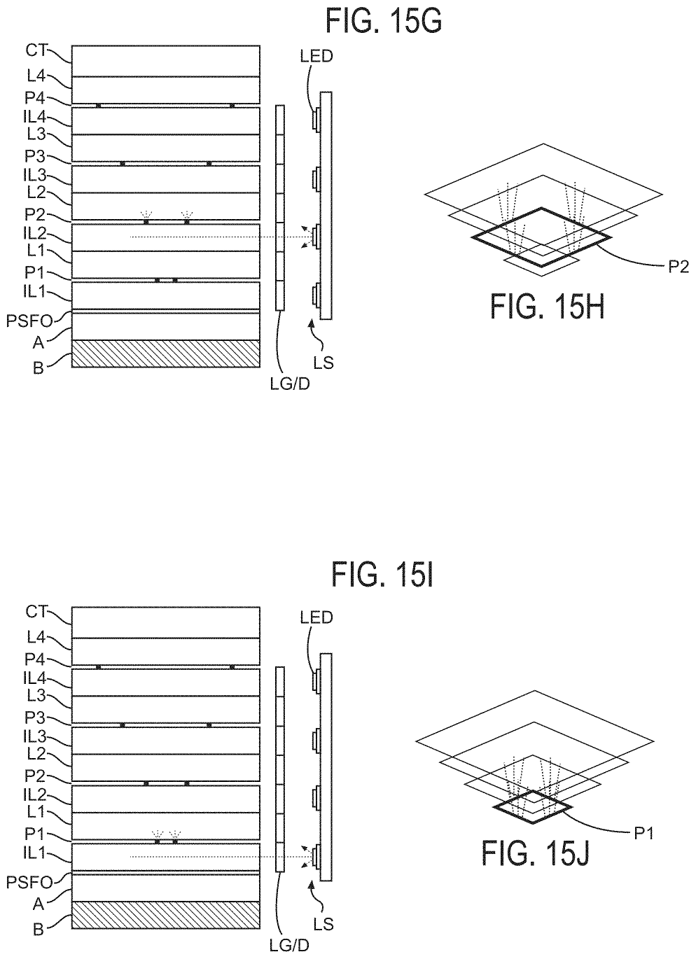

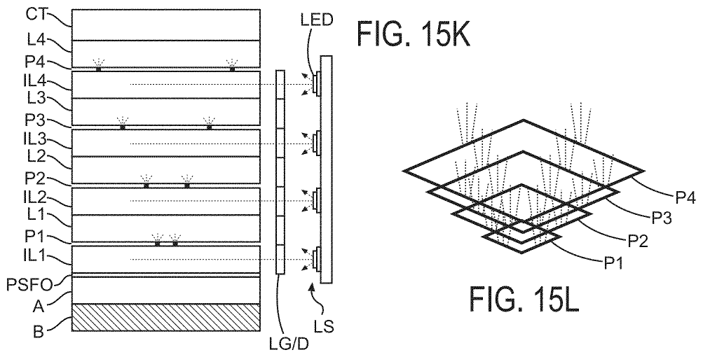

As indicated schematically according to an exemplary embodiment in FIGS. 15A-15L, the composite structure of component C may comprise a base B and an intermediate layer comprising a layer/treatment comprising an adhesive A and a layer comprising a printed safety film/optically clear adhesive PSFO and an inner layer IL1 (such as a glass layer/material) and a layer/print/paint P1 (with elements for a visual effect) and a layer/laminate L1 and an inner layer IL2 (such as a glass layer/material) and a layer/print/paint P2 (with elements for a visual effect) and a layer/laminate L2 and an inner layer IL3 and a layer/print/paint P3 (with elements for visual effect) and a layer/laminate L3 and an inner layer IL4 (such as a glass layer/material) and a layer/print/paint P4 (with elements for visual effect) and a layer/laminate L4 and cover T. As indicated schematically according to an exemplary embodiment in FIGS. 15C, 15E, 15G, 15I and 15L, a light source LS may comprise an LED arrangement/array (or display panel) configured as a side light to provide selectively controlled illumination into a light guide/diffuser LG/D (shown as segmented/with sections by layer) and into one or more selected inner layers of the composite structure to present/augment a visual effect comprising elements P from the treatment (e.g. coating, print, paint, etc.) as indicated schematically in FIGS. 15D, 15H, 15K and 15M and 13C; as indicated, the visual effect may comprise a depth effect comprising the selective illumination of elements P1/P2/P3/P4 (i.e. to produce the visual effect). See also FIGS. 2E-2F, 20A-20D, 21A-21C, 22A-22B and 23A-23B.

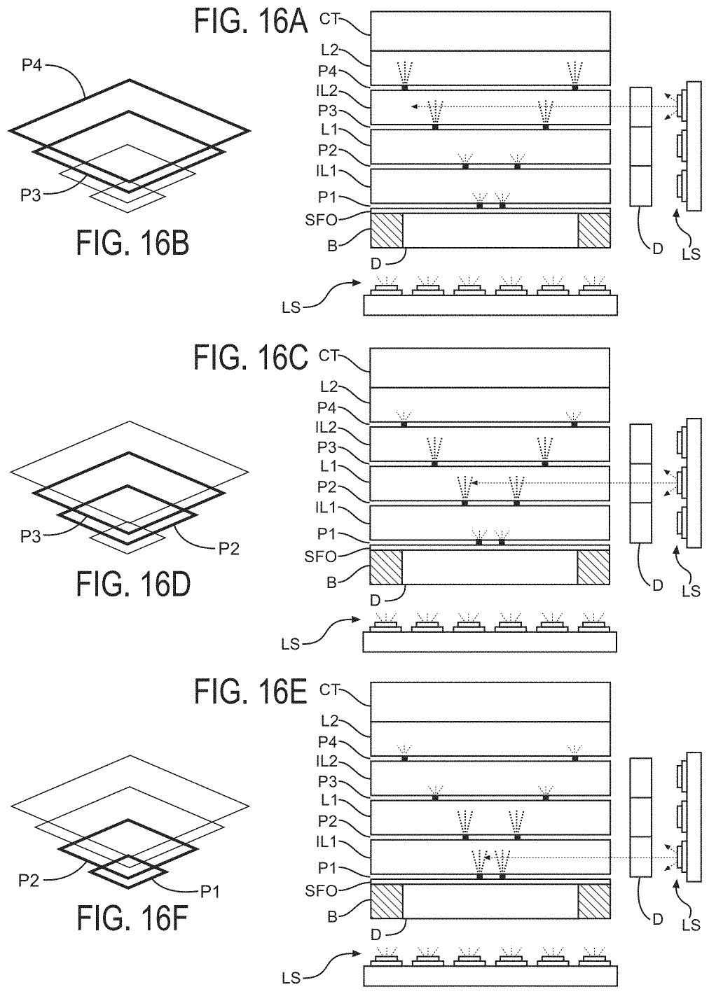

As indicated schematically according to an exemplary embodiment in FIGS. 16A-16E, the composite structure of component C may comprise a base B with a diffuser D and an intermediate layer comprising a layer/treatment comprising a safety film/optically clear adhesive SFO and a layer/print/paint P1 (with elements for a visual effect) for an inner layer IL1 (such as a glass layer/material) with a layer/print/paint P2 (with elements for a visual effect) and a layer/laminate L1 and a layer/print/paint P3 (with elements for a visual effect) for an inner layer IL2 (such as a glass layer/material) with a layer/print/paint P4 (with elements for visual effect) and a layer/laminate L2 and cover T. As indicated schematically according to an exemplary embodiment in FIGS. 16A, 16C and 16E, a light source LS may comprise an LED arrangement/array (or display panel) configured as a base light to provide selectively controlled illumination into diffuser D and as a side light to provide selectively controlled illumination into a light guide/diffuser LG/D (e.g. segmented/with sections by layer) and into one or more selected inner layers of the composite structure to present/augment a visual effect comprising elements P from the treatment (e.g. coating, print, paint, etc.) as indicated schematically in FIGS. 16B and 16D; as indicated, the visual effect may comprise a depth effect comprising the selective illumination of elements P1/P2/P3/P4 (i.e. to produce the visual effect). See also FIGS. 2E-2F, 20A-20D, 21A-21C, 22A-22B and 23A-23B.

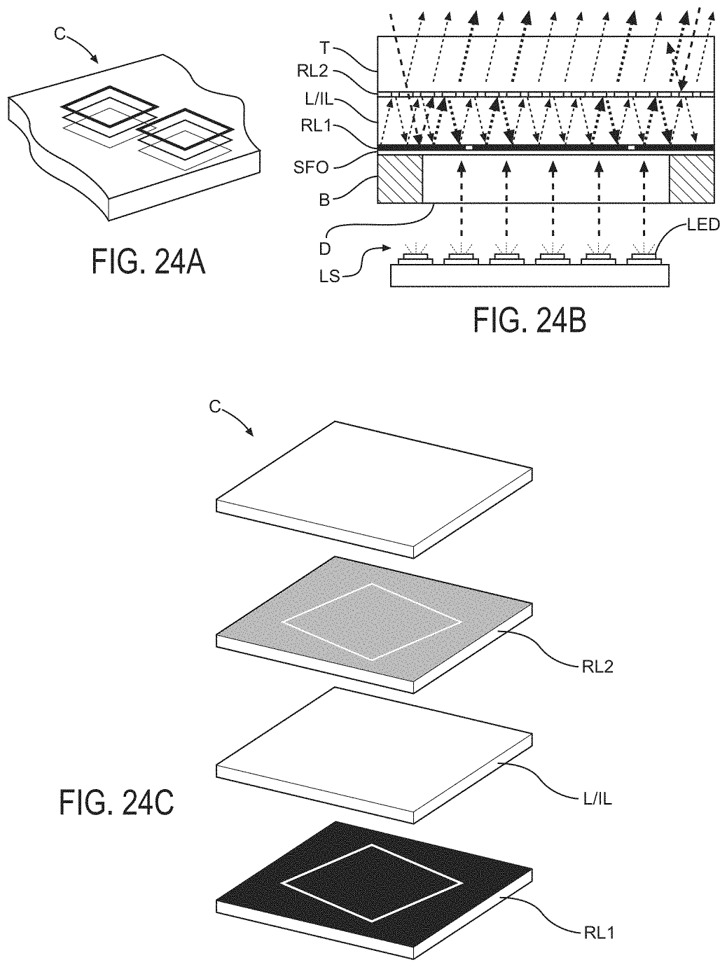

As indicated schematically according to an exemplary embodiment in FIGS. 24A-24C, the composite structure of component C may comprise a base B with a diffuser D and an intermediate layer comprising a layer/treatment comprising a safety film/optically clear adhesive SFO and a reflective layer RL1 (with treatment/elements for a visual effect) for an inner layer L/IL (such as a glass layer/material with optional laminate) and a reflective layer RL2 and cover T. As indicated schematically according to an exemplary embodiment in FIG. 24B, a light source LS may comprise an LED arrangement/array (or display panel) configured as a base light to provide selectively controlled illumination into diffuser D to present/augment a visual effect comprising elements from the treatment of the reflective layer RL1 (e.g. coating, print, paint, etc.) as indicated schematically in FIGS. 24A and 24C; as indicated, the visual effect may comprise a depth effect comprising the selective illumination of elements (i.e. to produce the visual effect). According to an exemplary embodiment as shown schematically in FIGS. 24A-24C, the component configured for illumination by a light source may comprise a composite structure comprising the cover T and the base B and the intermediate layer between the cover and the base. The cover may comprise a surface and a cover layer comprising a glass material; the base may comprise a substrate; the composite structure may be configured to provide a visual effect; the intermediate layer may comprise a reflective layer RL2 and an inner layer and a reflective layer RL1. Transmittance and reflectance of the reflective layer RL2 are selected to produce a substantially reflective surface; reflectance of the reflective layer RL1 may be selected to provide a mirror effect into the inner layer. The mirror effect of the reflective layer RL1 may comprise a substantially full mirror effect (see FIG. 24A); the reflective layer RL1 may comprise a light-transmissive pattern (see FIGS. 24A and 24C). Transmittance and reflectance of the reflective layer RL1 and the reflective layer RL2 may be selected to produce a depth effect (as indicated in FIG. 24A); the depth effect may be produced from transmitted illumination and reflected illumination within the intermediate layer. The depth effect may comprise a repeated visual effect of a pattern, see FIG. 24A. Illumination from the light source may be reflected between the reflective layer RL1 and the reflective layer RL2 to present a visual effect; the visual effect may comprise the pattern. The depth effect may comprise an “infinity” effect; the infinity effect may comprise a reflection effect within the intermediate layer; the reflection effect may comprise the pattern. The depth effect may be modified by distance between the reflective layer RL1 and the reflective layer RL2. The reflective layer RL1 may comprise a full mirror coating with a treatment such as elements shown as apertures/openings, etc. to permit transmission of illumination into the inner layer L/IL. See FIGS. 24B and 24C. The reflective layer RL1 may comprise a “full mirror” such that illumination from the base light source LS through the diffuser is transmitted (through apertures/openings) into the inner layer L/IL and illumination within inner layer L/IL is reflected from reflective layer RL1 toward reflective layer RL2 and/or toward cover TL, see FIG. 24B (schematically/representationally indicating direction of illumination and reflection for reflective layer RL1). The reflective layer RL2 may comprise a one-way mirror coating such that illumination from ambient environment may substantially be reflected from the surface, as indicated schematically in FIG. 24B (schematically/representationally indicating direction of illumination and reflection for reflective layer RL2). The transmission and reflection of illumination across and between reflective layer RL1 and reflective layer RL2 is intended to produce a depth effect (i.e. reflection effect, “infinity” effect, etc. with the element) visible in the intermediate layer; the depth effect which may be enhanced by enhanced intensity of illumination (i.e. to enhance the visual effect of the depth effect as presented to be perceived in the composite structure). See for example FIG. 24A (schematically/representationally indicating the visual effect referred to as depth effect, “infinity effect,” etc. at the cover of the component). According to an exemplary embodiment, the intermediate layer may comprise an element between a first reflective layer and a second reflective layer; the element may comprise an object. The cover may comprise a glass layer and a lamination; the intermediate layer may comprise a first inner glass layer and a treatment comprising a first reflective coating and a lamination and a second inner glass layer and a treatment comprising a second reflective coating and a safety film; the light source may comprise a back light.

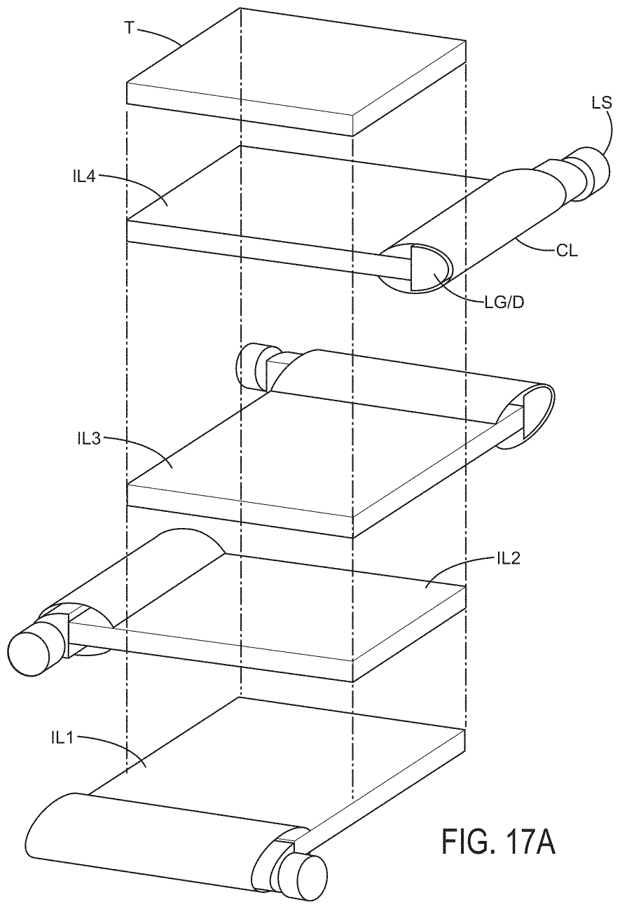

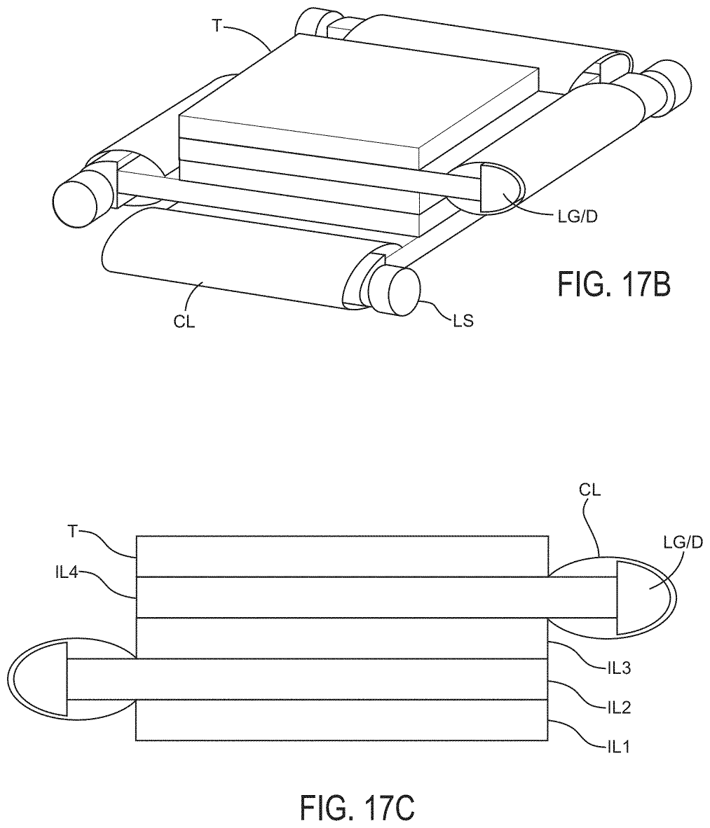

As indicated schematically according to an exemplary embodiment in FIGS. 17A-17C, the component may comprise a light guide arrangement CL configured to attach to a flange on each inner layer (e.g. glass material); the arrangement CL may comprise a light source LS and a light guide/diffuser LG/D. As indicated schematically in FIG. 17C, the arrangement is maintained by a clamping action (e.g. elastomeric clamp, mechanical clamp, etc.) to secure the light guide/diffuser output area to a side of each inner layer.

### Exemplary Embodiments—B

According to an exemplary embodiment as shown schematically in FIGS. 1B-1C, 2A-2F, 20A-20D, 21A-21C, 22A-22B and 23A-23B, the component C may comprise a composite structure CS configured to provide a variety of visual effects VS including a decorative effect and/or presentation of indicia IN and/or visible element E. See also TABLE A.

According to an exemplary embodiment as shown schematically in FIGS. 1B-1C, 2A-2F, 20A-20D, 21A-21C, 22A-22B and 23A-23B, a vehicle interior component configured for illumination by a light source may comprise a composite structure comprising (a) a cover and (b) a base and (c) an intermediate layer between the cover and the base. The cover may comprise a surface and a cover layer comprising a glass material. The base may comprise a substrate. The composite structure may be configured to provide a visual effect. When the light source provides illumination, the visual effect may comprise a composite visual effect; the composite structure may be configured to produce the composite visual effect on the composite structure and/or within the composite structure. The intermediate layer may comprise a decorative insert; the decorative insert may comprise a depth effect. The depth effect at the intermediate layer may be configured to be provided by illumination from the light source. The intermediate layer may comprise a treatment and/or an element configured to provide a visual effect. The treatment and/or element may comprise at least one of (a) an element on a film on a surface of a glass material of the intermediate layer; (b) an element on a coating on a surface of a glass material of the intermediate layer; (c) an element printed on a surface of a glass material of the intermediate layer; (d) an element painted on a surface of a glass material of the intermediate layer; (e) an element on a surface of a glass material of the intermediate layer; (f) a composite element on a surface of a glass material of the intermediate layer. The treatment and/or element may comprise at least one of (a) a decorative effect; (b) a coating; (c) printing; (d) paint; (e) a film; (f) a mask layer; (g) a mask; (h) a semi-reflective treatment; (i) a reflective treatment; (j) etching; (k) lasering; (l) engraving. The visual effect may comprise the element within the composite structure. The intermediate layer may comprise an inner layer comprising a glass layer. The glass layer may comprise an element; the element of the glass layer may comprise at least one of (a) an element on a film on a surface of the glass layer; (b) an element on a coating on a surface of the glass layer; (c) an element printed on a surface of the glass layer; (d) an element painted on a surface of the glass layer; (e) an element on a surface of the glass layer; (f) a composite element on each surface of the glass layer. The visual effect may comprise a pattern for the composite structure; the pattern may comprise at least one element of the glass layer of the intermediate layer of the composite structure. The visual effect may comprise a first visual effect when the composite structure is in a first state; the first state may be unilluminated by the light source. The first state may comprise a depth effect. The visual effect may comprise a second visual effect when the composite structure is in a second state; the second state may be illuminated by the light source. The second state may comprise an enhanced depth effect. The light source may comprise at least one of (a) a backlight; (b) a sidelight; (c) a backlight and a sidelight. At least one of the cover layer or the intermediate layer may comprise a glass material comprising a glass with a treatment comprising a treated surface. The treated surface may comprise at least one of (a) an etched surface; (b) a sand-blasted surface; (c) a scribed surface; (d) a laser scribed surface; (e) a surface configured to provide a tactile effect; (f) a surface configured to provide a haptic effect; (g) a surface configured to provide a texture appearance. The treatment may comprise at least one of (a) a coating; (b) printing; (c) painting; (d) inkjet printing; (e) a screen printing; (f) a laser ablated coating; (g) application of indicia; (h) etching; (i) laser ablation; (j) machining; (k) milling; (l) application of a reflective coating; (m) application of a semi-reflective coating; (n) application of a metalized coating; (o) application of a mirrored coating. The glass may comprise at least one of (a) tempered glass; (b) partially tempered glass; (c) chemically strengthened glass; (d) toughened glass; (e) thermally strengthened glass; (f) anti-reflective glass; (g) anti-glare glass; (h) iron-free glass; (i) coated glass; (j) mirror glass; (k) glass with a reflective coating. The composite structure may comprise a film layer. The cover may comprise a nonplanar surface. The intermediate layer may comprise a glass material; the glass material of the intermediate layer may comprise glass of generally uniform thickness of between 0.2 mm and 1.8 mm. The glass material of the intermediate layer may comprise glass of generally uniform thickness of between 0.55 mm and 1.1 mm. The glass may comprise at least one of (a) an iron-free glass material and (b) a chemically-strengthened glass material. The component may comprise a functional layer; the functional layer may comprise at least one of (a) a sensor; (b) a capacitive layer. The component may comprise indicia aligned with the functional layer on at least one of (a) an inner surface of the cover; (b) a surface of each inner layer.

According to an exemplary embodiment as shown schematically in FIGS. 24A-24B, a vehicle interior component configured for illumination by a light source may comprise a composite structure comprising (a) a cover and (b) a base and (c) an intermediate layer between the cover and the base. The cover may comprise a surface and a cover layer comprising a glass material. The base may comprise a substrate. The composite structure may be configured to provide a visual effect. The intermediate layer may comprise a first reflective layer and an inner layer and a second reflective layer. Transmittance and reflectance of the first reflective layer are selected to produce a substantially reflective surface; reflectance of the second reflective layer may be selected to provide a mirror effect into the inner layer. The mirror effect of the second reflective layer may comprise a substantially full mirror effect; the second reflective layer may comprise a light-transmissive pattern. Transmittance and reflectance of the first reflective layer and the second reflective layer may be selected to produce a depth effect; the depth effect may be produced from transmitted illumination and reflected illumination within the intermediate layer. The depth effect may comprise a repeated visual effect of a pattern. Illumination from the light source may be reflected between the first reflective layer and the second reflective layer to present a visual effect; the visual effect may comprise the pattern. The depth effect may comprise an infinity effect; the infinity effect may comprise a reflection effect within the intermediate layer; the reflection effect may comprise the pattern. The depth effect may be modified by distance between the first reflective layer and the second reflective layer. The second reflective layer may comprise a full mirror coating with apertures to permit transmission of illumination. The first reflective layer may comprise a one-way mirror coating. The intermediate layer may comprise an element between the first reflective layer and the second reflective layer; the element may comprise an object. The cover may comprise a glass layer and a lamination; the intermediate layer may comprise a first inner glass layer and a treatment comprising a first reflective coating and a lamination and a second inner glass layer and a treatment comprising a second reflective coating and a safety film; the light source may comprise a back light.

According to an exemplary embodiment as shown schematically in FIGS. 25A-25C, 26A-26C and 27, a vehicle interior component may be manufactured by a process comprising the steps of forming a composite structure comprising a cover and a base and an intermediate layer between the cover and the base; applying a treatment to the intermediate layer; applying a film configured to hold the cover together when broken. The treatment may comprise at least one of (a) a decorative effect; (b) a coating; (c) printing; (d) paint.

According to an exemplary embodiment as shown schematically in FIGS. 25A-25C, 26A-26C and 27, a vehicle interior component may be manufactured by a process comprising the steps of forming a generally clear cover; forming a generally clear inner layer; printing a film; joining the printed film to each inner layer with an optically clear adhesive; joining the cover, each inner layer with the printed film and a base. The film may be configured to hold the cover together when broken; the film may comprise at least one of (a) a decorative effect; (b) a coating; (c) printing; (d) paint configured to at least one of (1) block light; (2) transmit light; (3) diffuse light. The step of forming the cover may comprise at least one of (a) cutting the cover; (b) treating at least one edge of the cover; (c) deforming a planar surface of the cover into a nonplanar surface of the cover. The component may comprise at least one of (a) paint or printing on an inner surface of the cover; (b) paint or printing on an outer surface of each inner layer; (c) paint or printing on an inner surface of each inner layer.

According to an exemplary embodiment as shown schematically in FIGS. 1B-1C, 2A-2F, 20A-20D, 21A-21C, 22A-22B and 23A-23B, a vehicle interior component configured for illumination by a light source may comprise: a composite structure comprising (a) a cover and (b) a base and (c) an intermediate layer between the cover and the base. The cover may comprise a surface and a cover layer comprising a glass material. The base may comprise a substrate. The composite structure may be configured to provide a visual effect. When the light source is off the visual effect of the composite structure may comprise a decorative effect. When the light source provides illumination, the visual effect may comprise a composite visual effect. The composite structure may be configured to produce the composite visual effect on the composite structure and/or within the composite structure. The composite structure may be configured to produce the composite visual effect at the surface of the cover and/or at the intermediate layer. The cover may be configured to provide a visual effect. The visual effect at the cover may comprise a decorative effect. The visual effect at the cover may be configured to be provided by illumination from the light source. The cover layer may comprise an element configured to provide a visual effect. The cover layer may comprise a treatment configured to provide a visual effect. The treatment may comprise an element configured to provide a visual effect. The intermediate layer may be configured to provide a visual effect. The visual effect of the intermediate layer may comprise a decorative effect. The intermediate layer may comprise a decorative insert. The decorative insert may comprise a visual effect. The decorative effect may comprise a depth effect. The visual effect may comprise a depth effect. The visual effect at the intermediate layer may be configured to be provided by illumination from the light source. The intermediate layer may comprise a glass layer comprising an element configured to provide a visual effect. The intermediate layer may comprise a treatment configured to provide a visual effect. The treatment may comprise an element configured to provide a visual effect. The element may comprise at least one of (a) an element on a film on a surface of the glass layer of the intermediate layer; (b) an element on a coating on a surface of the glass layer of the intermediate layer; (c) an element printed on a surface of the glass layer of the intermediate layer; (d) an element painted on a surface of the glass layer of the intermediate layer; (e) an element on a surface of the glass layer of the intermediate layer; (f) a composite element on each surface of the glass layer of the intermediate layer. The intermediate layer may comprise a treatment; the treatment may comprise at least one of (a) a treatment on a film on a surface of the glass layer of the intermediate layer; (b) a treatment on a coating on a surface of the glass layer of the intermediate layer; (c) a treatment printed on a surface of the glass layer of the intermediate layer; (d) a treatment painted on a surface of the glass layer of the intermediate layer; (e) a treatment on a surface of the glass layer of the intermediate layer; (f) a composite treatment on each surface of the glass layer of the intermediate layer; (g) the element of the intermediate layer. The treatment may comprise at least one of (a) a decorative effect; (b) a coating; (c) printing; (d) paint; (e) a film; (f) a mask layer; (g) a mask; (h) a semi-reflective treatment; (i) a reflective treatment; (j) etching; (k), lasering; (l) engraving. The intermediate layer may comprise an inner layer. The intermediate layer may comprise at least one of (a) an inner layer under the cover and (b) and inner layer over the base. The intermediate layer may comprise (a) an inner layer under the cover and (b) and inner layer over the base. The intermediate layer may comprise a first inner layer and a second inner layer. Each inner layer may comprise a glass layer. The glass layer may comprise an element; the element of the glass layer may comprise at least one of (a) an element on a film on a surface of the second glass layer; (b) an element on a coating on a surface of the second glass layer; (c) an element printed on a surface of the second glass layer; (d) an element painted on a surface of the second glass layer; (e) an element on a surface of the second glass layer; (f) a composite element on each surface of the second glass layer. The first glass layer may comprise the element. The second glass layer may comprise the element. The composite visual effect may comprise the element within the composite structure. The composite visual effect may comprise the element illuminated within the composite structure. The composite visual effect may comprise a depth effect of the element within the composite structure. The composite visual effect may comprise a visual effect beneath the surface of the cover of the composite structure. The composite visual effect may comprise a visual effect at the surface of the cover of the composite structure. The composite visual effect may comprise a pattern for the composite structure. The pattern may comprise the element of the glass layer of the intermediate layer of the composite structure. The composite visual effect may comprise a first visual effect when the composite structure is in a first state. The first state may be unilluminated by the light source. The first state may comprise a depth effect. The composite visual effect may comprise a second visual effect when the composite structure is in a second state. The second state may be illuminated by the light source. The second state may comprise a depth effect. The second state may comprise an enhanced depth effect. The light source may comprise at least one of (a) a diffuser; (b) a display panel; (c) a LED panel; (d) an LED array; (e) and LED display; (f) a backlight under the base layer; (g) a sidelight; (h) a backlight and a sidelight; (i) a light guide; (j) a light. The visual effect may comprise a depth effect; the depth effect may be produced at the intermediate layer. The depth effect may be provided by illumination at the intermediate layer by the light source. The depth effect may be enhanced by illumination at the intermediate layer by the light source. At least one of the cover layer or the intermediate layer may comprise a glass material comprising a glass with a treatment comprising a treated surface. The treated surface may comprise at least one of (a) an etched surface; (b) a sand-blasted surface; (c) a scribed surface; (d) a laser scribed surface; (e) a surface configured to provide a tactile effect; (f) a surface configured to provide a haptic effect; (g) a surface configured to provide a texture appearance. The treatment may comprise at least one of (a) a coating; (b) printing; (c) painting; (d) inkjet printing; (e) a screen printing; (f) a laser ablated coating; (g) application of indicia; (h) etching; (i) laser ablation; (j) machining; (k) milling; (l) application of a reflective coating; (m) application of a semi-reflective coating; (n) application of a metalized coating; (o) application of a mirrored coating. The glass may comprise at least one of (a) tempered glass; (b) partially tempered glass; (c) chemically strengthened glass; (d) toughened glass; (e) thermally strengthened glass; (f) anti-reflective glass; (g) anti-glare glass; (h) iron-free glass; (i) coated glass; (j) mirror glass; (k) glass with a reflective coating. The intermediate layer may comprise an inner layer with a reflective layer. The cover layer may comprise the surface of the cover. The cover may be configured to allow light to pass through the cover. The composite structure may comprise a film layer. The film layer may comprise a film applied to the substrate. The cover may comprise a nonplanar surface. The treatment may comprise a film configured to hold the cover together when broken. The treatment may comprise at least a portion configured to block light. The treatment may be coupled to the cover by at least one of (a) vacuum; (b) pressure; (c) heat; (d) light; (e) adhesive; (f) physical bonding; (g) chemical bonding; (h) static forces. The component may comprise a light source configured to provide light intended to be visible to an occupant in the vehicle when the component is in operation after installation in the interior of the vehicle. The treatment may comprise a substantially opaque portion and a substantially transparent portion; the substantially opaque portion may be configured to block light from the light source or to prevent light from the light source to pass through an inner layer toward an outer surface of the cover. The cover may comprise an outer surface configured to present a user interface using light from the light source. The component may comprise a sensor configured for interaction at the outer surface of the cover. The sensor may be configured to provide a user interface. The sensor may be configured to operate as an input device. The cover may comprise glass. The glass of the cover may comprise a generally uniform thickness of between 0.2 mm and 1.8 mm. The glass of the cover may comprise a generally uniform thickness of between 0.55 mm and 1.1 mm. The glass of the cover may comprise at least one of (a) an iron-free glass material and (b) a chemically-strengthened glass material. The cover may comprise an outer surface; the outer surface of the glass may comprise a treated surface comprising the treatment. The component may comprise a functional layer; the functional layer may comprise at least one of (a) a sensor; (b) a capacitive layer; (c) a resistive layer; (d) a camera. The intermediate layer may comprise at least one of (a) an inner layer under the cover and (b) and inner layer over the base. The intermediate layer may comprise (a) an inner layer under the cover and (b) and inner layer over the base. Each inner layer may comprise at least one of (a) a light guide; (b) glass; (c) a laminate; (d) wood; (e) metal; (f) stone; (g) a fabric; (h) mirror; (i) semi-reflective surface. Each inner layer may be configured to provide a depth effect. The component may comprise a film coupled to each inner layer; the film may be configured to hold at least one of (a) the cover; (b) each inner layer together when broken. The treatment may comprise at least a portion configured to block light. The treatment may comprise a decorative coating/printing. The treatment may be configured to provide a decorative effect. The component may comprise a bonding component configured to join the cover and each inner layer. The bonding component may comprise at least one of (a) a lamination film; (b) a cast resin; (c) a foil. The component may comprise at least one of (a) paint or printing on an inner surface of the cover; (b) paint or printing on an outer surface of each inner layer; (c) paint or printing on an inner surface of each inner layer. The component may comprise a functional layer; the functional layer may comprise at least one of (a) a sensor; (b) a capacitive layer. The component may comprise indicia aligned with the functional layer on at least one of (a) an inner surface of the cover; (b) a surface of each inner layer.

According to an exemplary embodiment as shown schematically in FIGS. 24A-24C, a vehicle interior component configured for illumination by a light source may comprise a composite structure comprising (a) a cover and (b) a base and (c) an intermediate layer between the cover and the base. The cover may comprise a surface and a cover layer comprising a glass material. The base may comprise a substrate. The composite structure may be configured to provide a visual effect. The intermediate layer may comprise a first reflective layer and an inner layer and a second reflective layer. Transmittance and reflectance of the first reflective layer may be selected to produce a substantially reflective surface. Reflectance of the second reflective layer may be selected to provide a mirror effect into the inner layer. The mirror effect may comprise a substantially full mirror effect. Transmittance and reflectance of the first reflective layer and the second reflective layer may be selected to produce a depth effect. Transmittance and reflectance of the first reflective layer and the second reflective layer may be selected to enhance intensity of reflected light within the layer. The depth effect may be produced from transmitted illumination and reflected illumination within the intermediate layer. The depth effect may comprise a repeated visual effect of a pattern. The inner layer may comprise a glass material; the glass material may comprise a thin glass. The composite structure may comprise a low-mass structure. The glass material may comprise a chemically-strengthened glass. The glass material may comprise an alumina-silica glass. The glass material may comprise a substantially iron-free glass. The composite structure may comprise a compact construction. The first reflective layer may comprise a one-way mirror coating. The second reflective layer may comprise an element. The second reflective layer may comprise a pattern. Illumination from the light source may be reflected between the first reflective layer and the second reflective layer to present a visual effect. The visual effect may comprise the pattern. The visual effect may comprise a depth effect. The depth effect may comprise an infinity effect. The infinity effect may comprise a reflection effect. The reflection effect may comprise the pattern. The light source may comprise a back light. The light source may comprise a side light at the intermediate layer. Illumination from the back light enhances the depth effect. Illumination from the side light may enhance the depth effect. The intermediate layer may be configured so that the depth effect is lengthened with distance between the first reflective layer and the second reflective layer. The depth effect may be modified by distance between the first reflective coating and the second reflective coating. The second reflective coating may comprise a full mirror with apertures to permit transmission of illumination. The first reflective coating may comprise a one-way mirror. The first reflective layer may comprise a treatment. The second reflective layer may comprise a treatment. The treatment may comprise a coating. The composite structure may comprise a safety film layer. The intermediate layer may comprise a laminate layer. The intermediate layer may comprise a safety coating. The intermediate layer may comprise an element between the first reflective layer and the second reflective layer. The element may comprise an object. The cover may comprise a glass layer and a lamination film; the intermediate layer may comprise a first inner glass layer and a treatment comprising a first reflective coating and a lamination film and a second inner glass layer and a treatment comprising a second reflective coating and a safety film; the light source may comprise a back light.

According to an exemplary embodiment as shown schematically in FIGS. 25A-25C, 26A-26C and 27, a vehicle interior component may be manufactured by a process comprising the steps of: forming a composite structure comprising a cover and a base and an intermediate layer between the cover and the base; applying a treatment to the intermediate layer; and applying a film configured to hold the cover together when broken. The treatment may comprise at least one of (a) a decorative effect; (b) a coating; (c) printing; (d) paint.

According to an exemplary embodiment as shown schematically in FIGS. 25A-25C, 26A-26C and 27, a vehicle interior component may be manufactured by a process comprising the steps of: forming a generally clear cover; forming a generally clear inner layer; printing a film; joining the printed film to each inner layer with an optically clear adhesive; joining the cover, each inner layer with the printed film and a base. The film may be configured to hold the cover together when broken; the film may comprise at least one of (a) a decorative effect; (b) a coating; (c) printing; (d) paint configured to at least one of (1) block light; (2) transmit light; (3) diffuse light. The step of joining the cover to each inner layer may comprise laminating the cover to each inner layer with at least one of (a) a cast resin; (b) a film. The step of forming the cover may comprise at least one of (a) cutting the cover; (b) treating at least one edge of the cover; (c) deforming a planar surface of the cover into a nonplanar surface of the cover. The component may comprise at least one of (a) paint or printing on an inner surface of the cover; (b) paint or printing on an outer surface of each inner layer; (c) paint or printing on an inner surface of each inner layer. The process may comprise a step of treating an outer surface of the cover.

TABLE A

| | | | | | | Assembly/ |
|---|---|---|---|---|---|---|
| | | | | Light | | Manufacture |
| | | | Material | Transmission | Dimension | Method |
| Symbol | Element | Function | (example) | (example) | (example) | (example) |
| C | Vehicle | | Composite structure | Various | Overall: | Assembly |
| | interior | | | | 2.7-50 mm | |
| | component | | | | | |
| B | Base | Structural | Polypropylene (PP), | Opaque | 2-3 mm | Injection |
| | | component | PP-Glass Fiber/fill | | | molding |
| | | | (GF), Polycarbonate | | | |
| | | | (PC)/ABS, PA, PA-GF | | | |
| A | Adhesive | Levelling, thermal | Polyurethane (PU) | Opaque | 0.5-3 mm | Bead/rope |
| | | expansion | | | | application, |
| | | compensation | | | | foaming, etc. |
| SF | Safety film | Dual function: | PC, Polymethyl | Opaque, | 0.08-0.25 mm | Film, etc. |
| | | splinter protection; | methacrylate (PMMA) | transparent, | | |
| | | decorative | | may be optical | | |
| | | background | | clear | | |
| P | Paint/print | Paint on backside | PU, Acrylic, | Opaque, may | 10-100 microns | Screen print, |
| | | of SF may be | polyethylene | have opening, | | roll-to-roll, |
| | | opaque; print on | terephthalate (PET), | in register with | | Inkjet, spray |
| | | backside may be | Epoxy | pattern | | coating, etc. |
| | | decorative, may not | | printing | | |
| | | provide icons (due | | | | |
| | | to following deep | | | | |
| | | draw process) | | | | |
| C | Cover | Thin glass, prevent | Glass | Transparent, | 0.2-1.8 mm | Chemically |
| | | chipping and | | milky, treated, | (prefer | strengthened |
| | | flaking | | tinted/ | 0.55-1.1 mm) | (generally |
| | | | | colored | | preferred) |
| F | Film | Same as safety film | | | | |
| PSF | Printed | Combination SF | | | | |
| | safety film | and P | | | | |
| OCA | Optically | Optical clear | Acrylic, PU | Optical clear | 0.05-0.15 mm | Liquid: slot- |
| | clear | | | | | dye, spray, |
| | adhesive | | | | | etc. |
| T | Treatment | Optical adjustment | | Transparent, | Indentation | Solid film: |
| | | | | milky, treated, | depth: | roll-to-roll, |
| | | | | tinted/ | 5 micron- | etc. |
| | | | | colored | 0.3 mm | |
| IL, IL1, | Inner layer | Decorative inserts | Glass | Transparent, | 0.2-10 mm | Sand |
| IL2 | | | | tinted/ | (design | blasting, |
| | | | | colored | dependent) | etching, |
| | | | | | | grinding, |
| | | | | | | milling, |
| | | | | | | lasering, |
| | | | | | | printing, etc. |
| L, L1, | Laminate | Adhesive, | Ethylene-vinyl acetate | Transparent, | 0.05-2 mm | May be |
| L2 | | decorative | (EVA), Thermoplastic | tinted/ | | chemically |
| | | adhesive | polyurethane (TPU), | colored | | strengthened |
| | | | thermoplastic | | | (easier to |
| | | | polyolefin (TPO), | | | handle) |
| | | | Polyvinyl butyral | | | |
| | | | (PVB), (L)OCA | | | |
| | | | (liquid/optically clear | | | |
| | | | adhesive), PU | | | |
| LS | Light | | Any display/light; | | | Film or liquid |
| | source | | examples of LED, | | | |
| | | | OLED, | | | |
| | | | electroluminescent, | | | |
| | | | etc. | | | |
| S | Sensor | | Capacitive, Resistive, | | | |
| | | | wires, printed | | | |
| | | | electronics, etc. | | | |
| DI | Decorative | Design | Any suitable | | Design | |
| | insert | | decorative material, | | dependent | |
| | | | including but not | | | |
| | | | limited to wood, metal | | | |
| | | | mesh, flakes, wires, | | | |
| | | | fabric, objects (stones, | | | |
| | | | coins, glass, gems, | | | |
| | | | etc.) | | | |
| PC | Printed/ | | | | | Assembly |
| | painted | | | | | |
| | cover | | | | | |
| RL1 | Reflective | Full mirror | Any suitable reflective | Opaque with | 5-100 microns | Paint, spray, |
| | layer | (substantial effect | material including, | openings | | roll, inkjet, |
| | | intended) | Silver, Chrome, | | | screen, etc. |
| | | | Aluminum, Gold, | | | |
| | | | Palladium, Zinc, | | | |
| | | | Zirconium, metal | | | |
| | | | alloys, metal alloys; | | | |
| | | | treatment with | | | |
| | | | protective coating and | | | |
| | | | laser ablation/sand | | | |
| | | | blast/etching/milling; | | | |
| | | | metalized layer, etc. | | | |
| RL2 | Reflective | One-way mirror | Any suitable reflective | One-way | Transmission | Dip-coating, |
| | layer | (substantial effect | material including, | transparent, | dependent | roll-to-roll, |
| | | intended) | Silver, Chrome, | light blocking | | coating, PVD |
| | | | Aluminum, Gold, | from | | (physical |
| | | | Palladium, Zinc, | passenger | | vapor |
| | | | Zirconium, metal | point of view, | | deposition), |
| | | | alloys, metalized | transparent | | Sputtering, |
| | | | layer, etc. | from inside of | | etc. |
| | | | | the trim; 3- | | |
| | | | | 80% | | |
| PSFO | Printed | Combination of | | | | Dip-coating, |
| | safety film | layers | | | | roll-to-roll, |
| | with optical | | | | | coating, |
| | clear | | | | | PVD, |
| | adhesive | | | | | Sputtering, |
| | | | | | | etc. |
| T/CT | Cover with | Combination of | Glass | | | |
| | treatment | layers | | | | |
| D | Diffusor | Light diffusion | Polymeric resin, PC, | Milky, | 50 microns- | |
| | | (stand alone and/or | PMMA, PC/ABS, | transparent | 5 mm | |
| | | combined with | glass, etc. | | | |
| | | other element such | | | | |
| | | as display, layer, | | | | |
| | | etc.) | | | | |
| LG, | Light guide | Light direction and | Polymeric resin, PC, | Milky, | Design | Sheet |
| LG1, | | transmission | PMMA, PC/ABS, | transparent | dependent | extrusion, |
| LG2 | | | glass fiber, etc. | | | deep draw, |
| | | | | | | injection |
| | | | | | | mold, etc. |
| | Adhesive/ | | Polymeric resin, | Opaque | Design | Injection |
| | Attachment | | elastomeric material, | | dependent | molding, |
| | | | rubber, metal, etc. | | | extrusion, |
| | | | | | | etc. |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A vehicle interior component configured for illumination by a light source comprising:
a composite structure comprising (a) a cover and (b) a base and (c) an intermediate layer between the cover and the base;
wherein the cover comprises a surface and a cover layer comprising a glass material;
wherein the base comprises a substrate;
wherein the composite structure is configured to provide a visual effect.

2. The component of claim 1 wherein when the light source provides illumination the visual effect comprises a composite visual effect; wherein the composite structure is configured to produce the composite visual effect on the composite structure and/or within the composite structure.

3. The component of claim 1 wherein the intermediate layer comprises a decorative insert; wherein the decorative insert comprises a depth effect.

4. The component of claim 3 wherein the depth effect at the intermediate layer is configured to be provided by illumination from the light source.

5. The component of claim 1 wherein the intermediate layer comprises a treatment and/or an element configured to provide a visual effect.

6. The component of claim 5 wherein the treatment and/or element comprises at least one of (a) an element on a film on a surface of a glass material of the intermediate layer; (b) an element on a coating on a surface of a glass material of the intermediate layer; (c) an element printed on a surface of a glass material of the intermediate layer; (d) an element painted on a surface of a glass material of the intermediate layer; (e) an element on a surface of a glass material of the intermediate layer; (f) a composite element on a surface of a glass material of the intermediate layer.

7. The component of claim 5 wherein the treatment and/or element comprises at least one of (a) a decorative effect; (b) a coating; (c) printing; (d) paint; (e) a film; (f) a mask layer; (g) a mask; (h) a semi-reflective treatment; (i) a reflective treatment; (j) etching; (k) lasering; (l) engraving.

8. The component of claim 1 wherein the visual effect comprises a first visual effect when the composite structure is in a first state; wherein the first state is unilluminated by the light source; wherein the first state comprises a depth effect.

9. The component of claim 1 wherein the visual effect comprises a first visual effect when the composite structure is in a first state; wherein the first state is unilluminated by the light source; wherein the visual effect comprises a second visual effect when the composite structure is in a second state; wherein the second state is illuminated by the light source.

10. The component of claim 1 further comprising a functional layer; wherein the functional layer comprises at least one of (a) a sensor; (b) a capacitive layer.

11. The component of claim 10 further comprising indicia aligned with the functional layer on at least one of (a) an inner surface of the cover; (b) a surface of the intermediate layer.

12. A vehicle interior component configured for illumination by a light source comprising:
a composite structure comprising (a) a cover and (b) a base and (c) an intermediate layer between the cover and the base;
wherein the cover comprises a surface and a cover layer comprising a glass material;
wherein the base comprises a substrate;
wherein the composite structure is configured to provide a visual effect;
wherein the intermediate layer comprises an inner layer comprising a glass layer.

13. The component of claim 12 wherein the glass layer comprises an element; wherein the element of the glass layer comprises at least one of (a) an element on a film on a surface of the glass layer; (b) an element on a coating on a surface of the glass layer; (c) an element printed on a surface of the glass layer; (d) an element painted on a surface of the glass layer; (e) an element on a surface of the glass layer; (f) a composite element on each surface of the glass layer.

14. The component of claim 12 wherein the visual effect comprises a pattern for the composite structure; wherein the pattern comprises at least one element of the glass layer of the intermediate layer of the composite structure.

15. The component of claim 12 wherein the glass layer comprises glass of generally uniform thickness of between 0.2 mm and 1.8 mm.

16. A vehicle interior component configured for illumination by a light source comprising:
a composite structure comprising (a) a cover and (b) a base and (c) an intermediate layer between the cover and the base;
wherein the cover comprises a surface and a cover layer comprising a glass material;
wherein the base comprises a substrate;
wherein the composite structure is configured to provide a visual effect;
wherein the intermediate layer comprises a first reflective layer and an inner layer and a second reflective layer.

17. The component of claim 16 wherein transmittance and reflectance of the first reflective layer are selected to produce a substantially reflective surface; wherein reflectance of the second reflective layer is selected to provide a mirror effect into the inner layer.

18. The component of claim 16 wherein transmittance and reflectance of the first reflective layer and the second reflective layer are selected to produce a depth effect; wherein the depth effect is produced from transmitted illumination and reflected illumination within the intermediate layer.

19. The component of claim 16 wherein the first reflective layer comprises a one-way mirror coating.

20. The component of claim 16 wherein the cover comprises a glass layer and a lamination; wherein the intermediate layer comprises a first inner glass layer and a treatment comprising a first reflective coating and a lamination and a second inner glass layer and a treatment comprising a second reflective coating and a safety film; wherein the light source comprises a back light.
